(19) United States
(12) Patent Application Publication
(10) Pub. No.: US 2007/0112816 A1
(43) Pub. Date: May 17, 2007

(54) INFORMATION PROCESSING APPARATUS, INFORMATION PROCESSING METHOD AND PROGRAM

(75) Inventors: Hirooki HAYASHI, Kawasaki (JP); Naoyuki NOZAKI, Kawasaki (JP); Hidekatsu SASAKI, Kawasaki (JP); Shunichiro KOISO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/276,718

(22) Filed: Mar. 10, 2006

(30) Foreign Application Priority Data
Nov. 11, 2005 (JP) 2005-327181

(51) Int. Cl. G06F 7/00

(52) U.S. Cl. 707/101

(57) ABSTRACT

The present invention provides an information processing apparatus comprising: a storage unit for storing information relating to an execution of an operation and storing a transition which indicates a handling corresponding to the information; a flow processing unit for building up a work flow which is expressed by using the information and the transition based on the information necessary for obtaining a final product dealt with by the operation; and an output unit for outputting the work flow.

### BACKGROUND OF THE INVENTION

1. Field of the Invention

The present invention relates to an information processing apparatus, information processing method and program, and in particular to a technique affectively applicable to an information processing technique for assisting an analysis, a construction, an execution, et cetera, of a business operation.

2. Description of the Related Art

There is a method of setting handling information in each process of a flow as an attribute in a work flow expressing a flow of a business operation (also simply an “operation” hereinafter) and detecting a problematic process from an input and output relationship of the information as a method for analyzing the operation by focusing on the flow of information.

For example, a patent document 1 has disclosed an operation analysis assistance method, handling description data, as input, in the form of a table listing a processing subject and processing procedure of an operation as the subject of analysis, plus an attribute for the purpose of quantifying characteristics of the aforementioned items for each processing step, for modeling the aforementioned operation by quantifying the description data and extracting a characteristic of the operation by comparing with an operation characteristic pattern and for creating an improvement plan based on the model.

A patent document 2 has disclosed a technique for categorizing an operation process into a judgment process and a work process by breaking up the operation process and making a unit process by consolidating work processes allowing an execution under a setup condition of each judgment process and by placing the consolidated work processes in the downstream of the aforementioned judgment process. This is followed by creating a work execution program so as to be able to continuously execute a plurality of processes which is included in the unit process, extracting a plurality of processes allowing execution of work based on common data from work processes of the smallest unit and building up a parallel work flow enabling execution of these processes in parallel.

A patent document 3 has disclosed a technique for detecting information used at the time of carrying out each process for each process constituting a work flow and information necessary for carrying out the aforementioned process and comparing these pieces of information with information used in a final product obtained as a result of carrying out the process. Followed by categorizing the information used in a final product as value added information and information unused in a final product as non-value added information and displaying each of the aforementioned pieces of information by relating them with the process, there by attempting to identify unnecessary information and help to improve the operation.

The above noted conventional technique manages information by a process unit of an operation flow when analyzing the operation.

An operation flow is defined as expressing an execution sequence and unit of a process. The execution sequence and unit are some procedures which are determined by an operating aspect of the operation and the allocated resource, and are independent of an information flow. Therefore it is hard to analyze an information flow by using an operation flow.

Because of this, if there is a complex information flow within a process, it is necessary to redefine it by breaking up the process, because a presence of a problem in the flow cannot be analyzed, thus a technical problem of the process management becoming cumbersome arises.

In the case of having redefined a process, defining the process is cumbersome. And defining information associated with defining the process is also cumbersome. In addition, an interdependency relationship of information is hard to check. As a result, there is a possibility of setup mistakes occurring, such as a duplicate setup and a failure to setup, thus concerns over a reduced accuracy and reliability of an operation analysis arise.

Furthermore, redefining a process requires knowledge of the applicable operation and the relevant process, thus lacking versatility.

[Patent document 1] laid-open Japanese patent application publication No. 2002-352064

[Patent document 2] laid-open Japanese patent application publication No. 2005-100433

[Patent document 3] laid-open Japanese patent application publication No. 2001-256332

### SUMMARY OF THE INVENTION

A purpose of the present invention is to provide an information processing technique capable of carrying out an analysis and evaluation of an operation easily without requiring a cumbersome processing such as redefining processes constituting an operation.

Another purpose of the present invention is to provide an information processing technique capable of preventing a degradation of an accuracy and reliability of an operation analysis caused by an incomplete definition of information.

Yet another purpose of the present invention is to provide an information processing technique suitable to being applied to diverse operations generally without requiring much knowledge of an operation as the subject of analysis.

A first aspect of the present invention is to provide an information processing apparatus, comprising: a storage unit for storing information relating to an execution of an operation and storing a transition which indicates a handling corresponding to the information; a flow processing unit for building up a work flow which is expressed by using the information and the transition based on the information necessary for obtaining a final product dealt with by the operation; and an output unit for outputting the work flow.

A second aspect of the present invention is to provide the information processing apparatus according to the first aspect, wherein the storage unit includes a first storage unit for storing an information name, by correlating with its value, relating to information used for an operation execution, a second storage unit for storing a category of a transition which is a handling corresponding to the information, a third storage unit for managing a correlation between a name of the transition and the category, a fourth storage unit for defining a rule of the handling corresponding to the information in the transition, and a fifth storage unit for storing a correlation of the rule among each piece of the information, the transition at an input destination and/or at an output source of the aforementioned information, and the transition.

A third aspect of the present invention is to provide the information processing apparatus according to the first aspect, wherein the flow processing unit further carries out the processing of outputting the information, as terminal information, in which the transition of the output source does not exist, into the work flow so as to be distinguishable from other of the information.

A fourth aspect of the present invention is to provide the information processing apparatus according to the first aspect, wherein the flow processing unit further carries out the processing of outputting each of the transitions within the work flow so as to be distinguishable per each of the categories.

A fifth aspect of the present invention is to provide the information processing apparatus according to the first aspect, wherein the flow processing unit further carries out the processing of outputting, to the output unit, by totaling the number of the transitions existing in a path for each path from the information as a start point to the final product in the work flow.

A sixth aspect of the present invention is to provide the information processing apparatus according to the first aspect, wherein the flow processing unit further carries out the processing of detecting a path, as a sub-flow, reaching the transition specified by way of the input unit from the information which constitutes a start point, and outputting the number of the sub-flows as a degree of multiplexing to the output unit in the work flow.

A seventh aspect of the present invention is to provide the information processing apparatus according to the first aspect, wherein the flow processing unit further carries out the processing of detecting a path, as a sub-flow, reaching the transition specified by way of the input unit from the information which constitutes a start point, totaling the number of the transitions included in the sub-flow and outputting to the output unit as a degree of congestion in the work flow.

An eighth aspect of the present invention is to provide an information processing method, comprising: a first step for building up a work flow for expressing a flow of information by using a final product dealt with by an operation, the information necessary for obtaining the final product and a transition expressing a handling corresponding to the information; and a second step for analyzing the operation based on the work flow.

A ninth aspect of the present invention is to provide the information processing method according to the eighth aspect, wherein the second step is for evaluating the operation based on the number of pieces of the information external to the ones which are generated by the operation.

A tenth aspect of the present invention is to provide the information processing method according to the eighth aspect, wherein the first step is for building up the work flow by categorizing the transition according to a category of a handling corresponding to the information at the aforementioned transition, and the second step is for visually displaying the transition within the work flow so as to be distinguishable per each of the categories.

An eleventh aspect of the present invention is to provide the information processing method according to the eighth aspect, wherein the first step is for building up the work flow by categorizing the transition according to a category of a handling corresponding to the information at the aforementioned transition, and the second step is for totaling the number of the transitions per each of the categories and outputting a result by totaling the number of transitions per each of the categories.

A twelfth aspect of the present invention is to provide the information processing method according to the eighth aspect, wherein the second step is for totaling the number of the transitions which a relevant path passes through per each of a plurality of paths from the information, which constitutes a start point within the work flow, to the final product, and outputting the number of the transitions per each of the paths.

A thirteenth aspect of the present invention is to provide the information processing method according to the eighth aspect, wherein the second step is for detecting, as a sub-flow, a path from the information, which constitutes a start point within the work flow, to the one aforesaid transition, and outputting the number of the sub-flows and/or the number of the transitions included in each of the sub-flows.

A fourteenth aspect of the present invention is to provide the information processing method according to the eighth aspect, wherein the second step is for detecting, as a sub-flow, a path from the information, which constitutes a start point within the work flow, to the one aforesaid transition, and detecting and outputting a congestion of the information in the work flow based on the number of the transitions included in each of the sub-flows and weight information, being added to each of the transitions, for indicating a handling volume of the information.

A fifteenth aspect of the present invention is to provide a program for making a computer execute: a first step for building up a work flow for expressing a flow of information by using a final product dealt with by an operation, the information necessary for obtaining the final product and a transition expressing a handling corresponding to the information; and a second step for analyzing the operation based on the work flow.

A sixteenth aspect of the present invention is to provide the program according to the fifteenth aspect, wherein the second step is for visually displaying the number of the pieces of the information external to the ones which are generated by the operation by extraction from the work flow.

A seventeenth aspect of the present invention is to provide the program according to the fifteenth aspect, wherein the first step is for building up the work flow by categorizing the transition according to a category of a handling relative to the information at the aforementioned transition, and the second step is for displaying the transition within the work flow so as to be distinguishable per each of the category.

An eighteenth aspect of the present invention is to provide the program according to the fifteenth aspect, wherein the first step is for building up the work flow by categorizing the transition according to a category of a handling relative to the information at the aforementioned transition, and the second step is for totaling the number of the transitions per each of the categories and outputting a result of the totaling of the number of transitions per each of the categories.

A nineteenth aspect of the present invention is to provide the program according to the fifteenth aspect, wherein the second step is for carrying out at least one of the processing of detecting a path, as a sub-flow, a path from the information, which constitutes a start point within the work flow, to the one afore said transition and displaying the number of the sub-flows, or detecting a path, as a sub-flow, a path from the information, which constitutes a start point within the work flow, to the one aforesaid transition and displaying the number of the transitions included in each of the sub-flows.

A twentieth aspect of the present invention is to provide the program according to the fifteenth aspect, wherein the second step is for detecting, as a sub-flow, a path from the information, which constitutes a start point within the work flow, to the one aforesaid transition, and detecting and outputting a congestion of the information in the work flow based on the number of the transitions included in each of the sub-flows and weight information, being added to each of the transitions, for indicating a handling volume of the information.

The present invention expresses a flow of information dealt with by an operation by connecting information which is desired to be obtained as an outcome of the operation (called a “final product” hereinafter), the information necessary for obtaining the final product and a transition which is a handling corresponding to the information, for example. That is, to define a flow of information without considering a process.

This enables an easy analysis by focusing on a flow of information. Cumbersome tasks such as a definition and a redefinition of a process, et cetera, are no longer required, hence making it possible to simply carry out an analysis and evaluation of an operation.

And an interdependency relationship of information can be easily checked because a process flow is created retroactively while judging necessary information based on the final product. Accordingly, setup mistakes such as a duplicate setup and overlooked setup are eliminated, hence improving an accuracy and a reliability of an operation analysis result.

And storing a relationship between information and a transition once set up enables an easy setup in the case of setting up the same operation corresponding to information subsequently.

And a work for a definition or redefinition, et cetera, is no longer required because of an absence of consideration of a process, thereby enabling a person with absolutely no knowledge of the operation content to carry out an operation analysis. That is, making it applicable to diverse operation analyses, thus increasing versatility.

### BRIEF DESCRIPTION OF THE DRAWINGS

FIG. 1 is a conceptual diagram exemplifying an operation of an information processing apparatus embodying an information processing method according to an embodiment of the present invention;

FIG. 2 is a conceptual diagram exemplifying a configuration of an information processing apparatus embodying an information processing method according to an embodiment of the present invention;

FIG. 3 is a conceptual diagram exemplifying a flow management table for use in an information processing apparatus embodying an information processing method according to an embodiment of the present invention;

FIG. 4 is a conceptual diagram exemplifying an information management table for use in an information processing apparatus embodying an information processing method according to an embodiment of the present invention;

FIG. 5 is a conceptual diagram exemplifying a transition category management table for use in an information processing apparatus embodying an information processing method according to an embodiment of the present invention;

FIG. 6 is a conceptual diagram exemplifying a transition management table for use in an information processing apparatus embodying an information processing method according to an embodiment of the present invention;

FIG. 7 is a conceptual diagram exemplifying a rule management table for use in an information processing apparatus embodying an information processing method according to an embodiment of the present invention;

FIG. 8 is a conceptual diagram exemplifying a connection relationship management table for use in an information processing apparatus embodying an information processing method according to an embodiment of the present invention;

FIG. 9 is a conceptual diagram exemplifying terminal information for use in an information processing apparatus embodying an information processing method according to an embodiment of the present invention;

FIG. 10 is a conceptual diagram exemplifying terminal information for use in an information processing apparatus embodying an information processing method according to an embodiment of the present invention;

FIG. 11 is a conceptual diagram exemplifying terminal information for use in an information processing apparatus embodying an information processing method according to an embodiment of the present invention;

FIG. 12 is a conceptual diagram exemplifying terminal information for use in an information processing apparatus embodying an information processing method according to an embodiment of the present invention;

FIG. 13 is a conceptual diagram exemplifying an output format for a series of information constituting a final product dealt with by an information processing apparatus embodying an information processing method according to an embodiment of the present invention;

FIG. 14 is a conceptual diagram exemplifying an output format for a series of information constituting a final product dealt with by an information processing apparatus embodying an information processing method according to an embodiment of the present invention;

FIG. 15 is a flow chart exemplifying an operation of an information processing apparatus embodying an information processing method according to an embodiment of the present invention;

FIG. 16 is a conceptual diagram exemplifying a generation process of a work flow in an information processing apparatus embodying an information processing method according to an embodiment of the present invention;

FIG. 17 is a conceptual diagram exemplifying a work flow 50 generated by an information processing apparatus embodying an information processing method according to an embodiment of the present invention;

FIG. 18 is a flow chart exemplifying an operation of an information processing apparatus embodying an information processing method according to an embodiment of the present invention;

FIG. 19 is a conceptual diagram exemplifying a content of a flow management table according to an embodiment of the present invention;

FIG. 20 is a conceptual diagram exemplifying a content of an information management table according to an embodiment of the present invention;

FIG. 21 is a conceptual diagram exemplifying a content of a transition management table according to an embodiment of the present invention;

FIG. 22 is a conceptual diagram exemplifying a content of a connection relationship management table according to an embodiment of the present invention;

FIG. 23 is a conceptual diagram exemplifying a buildup of a work flow which is generated according to an embodiment of the present invention;

FIG. 24 is a conceptual diagram exemplifying an operation of a transition according to an embodiment of the present invention;

FIG. 25 is a conceptual diagram exemplifying an operation of a transition according to an embodiment of the present invention;

FIG. 26 is a conceptual diagram exemplifying an operation of a transition according to an embodiment of the present invention;

FIG. 27 is a conceptual diagram exemplifying a content of a transition category management table according to an embodiment of the present invention;

FIG. 28 is a conceptual diagram exemplifying a content of a transition management table according to an embodiment of the present invention;

FIG. 29 is a conceptual diagram exemplifying a content of a rule management table according to an embodiment of the present invention;

FIG. 30 is a conceptual diagram exemplifying a content of a connection relationship management table according to an embodiment of the present invention;

FIG. 31 is a conceptual diagram exemplifying a buildup of a work flow generated according to an embodiment of the present invention;

FIG. 32 is a conceptual diagram exemplifying a content of a transition category management table according to an embodiment of the present invention;

FIG. 33 is a conceptual diagram exemplifying a buildup of a work flow generated according to an embodiment of the present invention;

FIG. 34 is a conceptual diagram exemplifying an analysis result output according to an embodiment of the present invention;

FIG. 35 is a conceptual diagram exemplifying a buildup of a work flow generated according to an embodiment of the present invention;

FIG. 36 is a conceptual diagram exemplifying a result of analyzing a degree of multiplexing which is output in an embodiment of the present invention;

FIG. 37 is a conceptual diagram exemplifying a result of analyzing a congestion which is output in an embodiment of the present invention;

FIG. 38 is a conceptual diagram exemplifying a content of a transition management table according to an embodiment of the present invention; and

FIG. 39 is a conceptual diagram exemplifying an improvement of a work flow according to an embodiment of the present invention.

### DESCRIPTION OF THE PREFERRED EMBODIMENTS

The following is a detailed description of the preferred embodiment of the present invention while referring to the accompanying drawings.

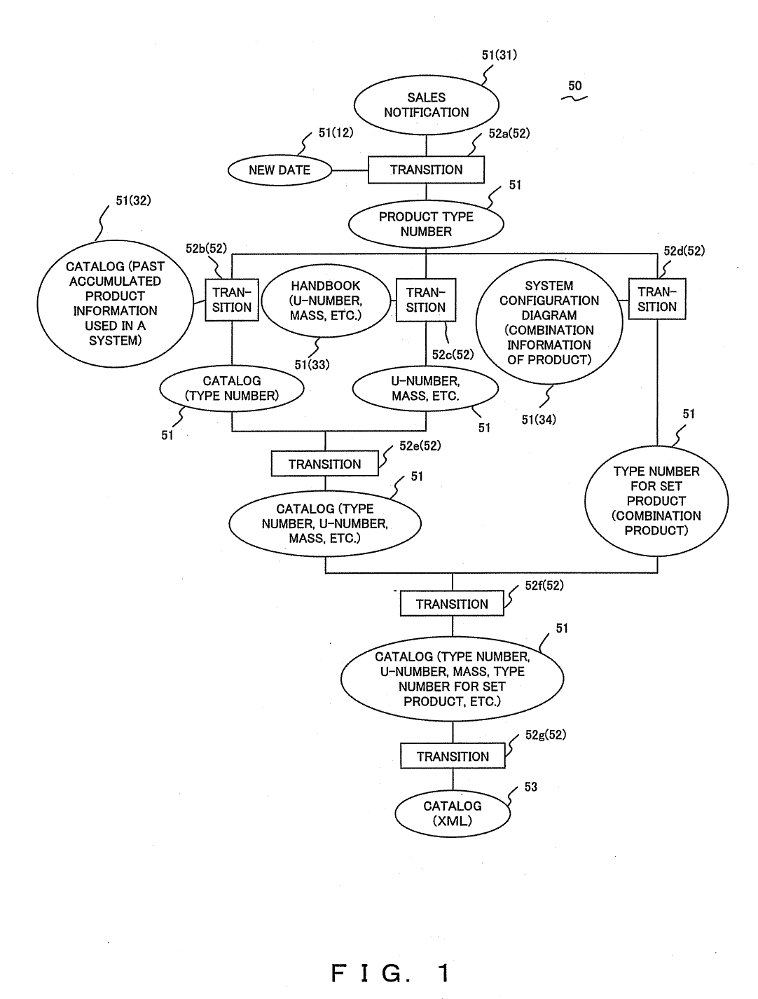

FIG. 1 is a conceptual diagram exemplifying an operation of an information processing apparatus for embodying an information processing method according to an embodiment of the present invention.

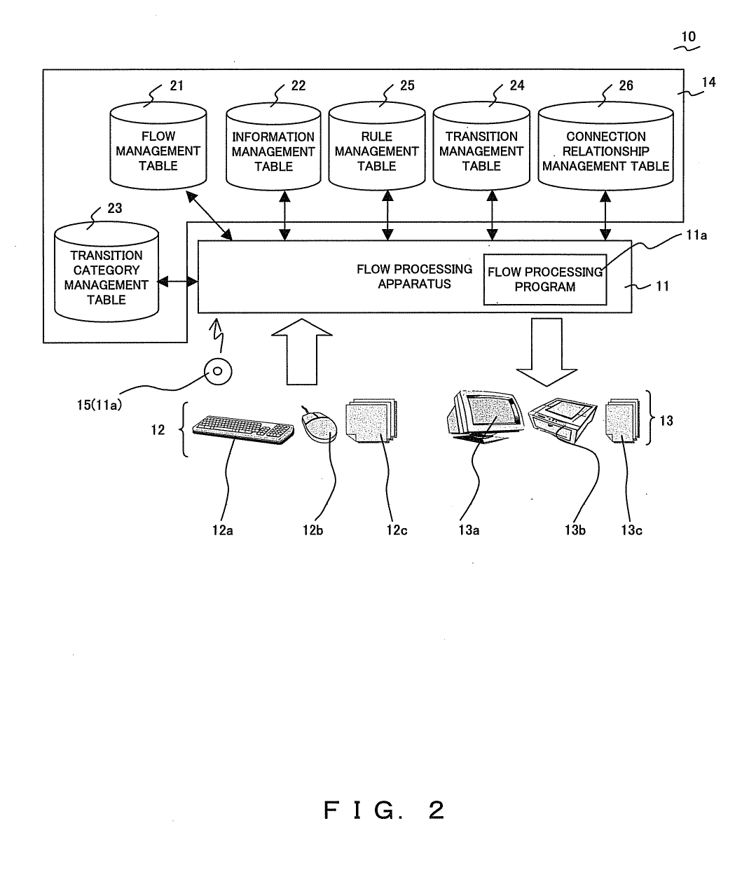

FIG. 2 is a conceptual diagram exemplifying a configuration of an information processing apparatus for embodying an information processing method according to an embodiment of the present invention.

As exemplified by FIG. 2, an information processing apparatus 10 includes a flow processing apparatus 11, an input apparatus 12, an output apparatus 13 and a storage apparatus 14.

The flow processing apparatus 11, comprising a central processing apparatus and a main storage, et cetera, for example, carries out a later described processing by executing a flow processing program 11a.

The input apparatus 12, comprising information input equipment such as a key board 12a, mouse 12b, et cetera, or a file 12c, et cetera, performs an information input to the flow processing apparatus 11.

The output apparatus 13, comprising a display 13a, a printer 13b, a file 13c, et cetera, carries out the processing of displaying information output from the flow processing apparatus 11 in the display 13a, printing on a paper medium (not shown herein) by the printer 13b or outputting to the file 13c.

The flow processing program 11a is distributed by storing it in a computer readable storage medium 15 for example. The flow processing apparatus 11 reads the flow processing program 11a out of the storage medium 15 for installing it in the own apparatus. Alternatively, the flow processing program 11a can be installed in the flow processing apparatus 11 by way of a telecommunication medium (not shown herein), in lieu of the storage medium 15.

The flow processing program 11a comprises, for example, the function of building up a work flow 50 for an operation for obtaining a final product 53 from information 51 and a transition 52 as described later.

And the flow processing program 11a comprises the function of analyzing the number of the transition 52 in each path within the work flow 50.

And the flow processing program 11a comprises the function of analyzing a degree of multiplexing of sub-flows (which is described later) by extracting the aforementioned sub-flow within the work flow 50.

And the flow processing program 11a comprises the function of analyzing a congestion based on the number of the transitions 52 included in each sub-flow.

The present embodiment is configured to make the storage apparatus 14 store a flow management table 21, information management table 22, transition category management table 23, transition management table 24, rule management table 25 and connection relationship management table 26.

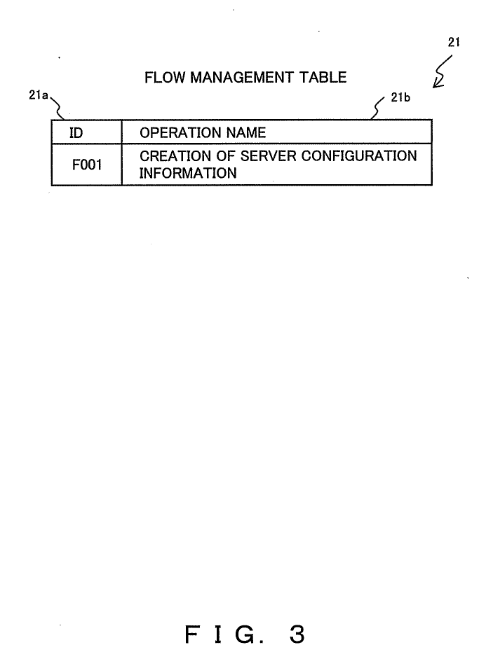

As exemplified by FIG. 3, the flow management table 21 stores an operation ID 21a and operation name 21b by correlating them as one record. The flow management table 21 is used for managing a work flow 50 which is generated as described later. FIG. 3 exemplifies the case of a work flow relating to an operation (i.e., an operation name 21b) called “creation of server configuration information” being managed by the operation ID 21a of “F001”.

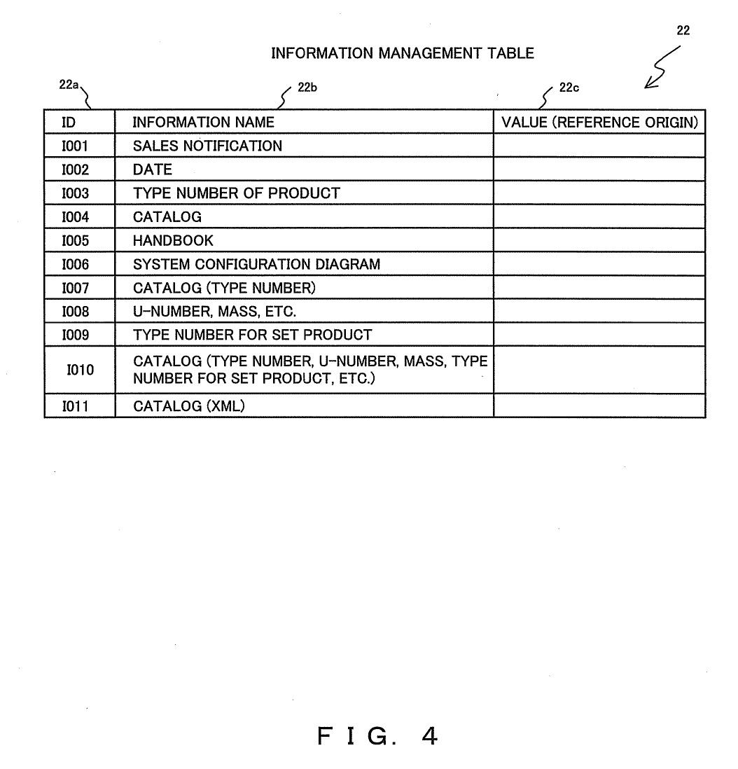

As exemplified by FIG. 4, the information management table 22 according to the present embodiment stores an information ID 22a, information name 22b and value 22c by correlating them as one record. The information name 22b is a name given to information as the subject of management, while the value 22c is a specific content of the information. A unique operation ID 21a is given to each pair of the information name 22b and value 22c.

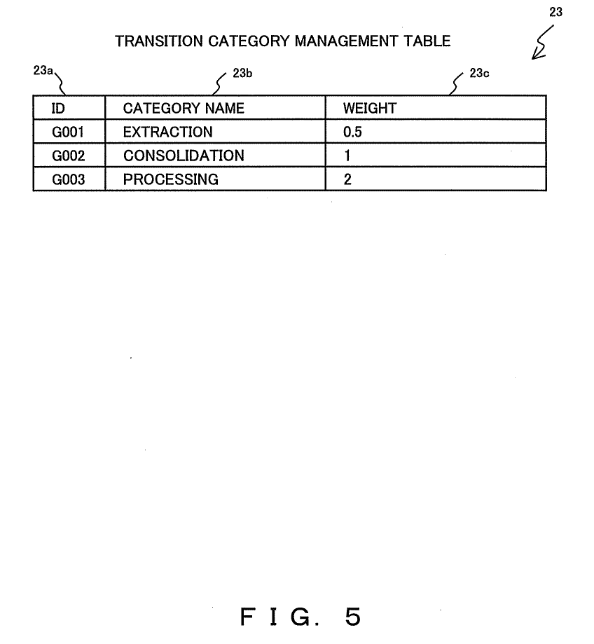

As exemplified by FIG. 5, the transition category management table 23 according to the present embodiment stores a category ID 23a, category name 23b and weight 23c by correlating them as one record.

The category name 23b indicates an attribute of each transition 52 as later described, while the weight 23c is a “weight” indicating a size, et cetera, of a processing load between the aforementioned transition 52 and other transitions 52. The category ID 23a is identifier information for uniquely identifying a transition 52 of each category name 23b.

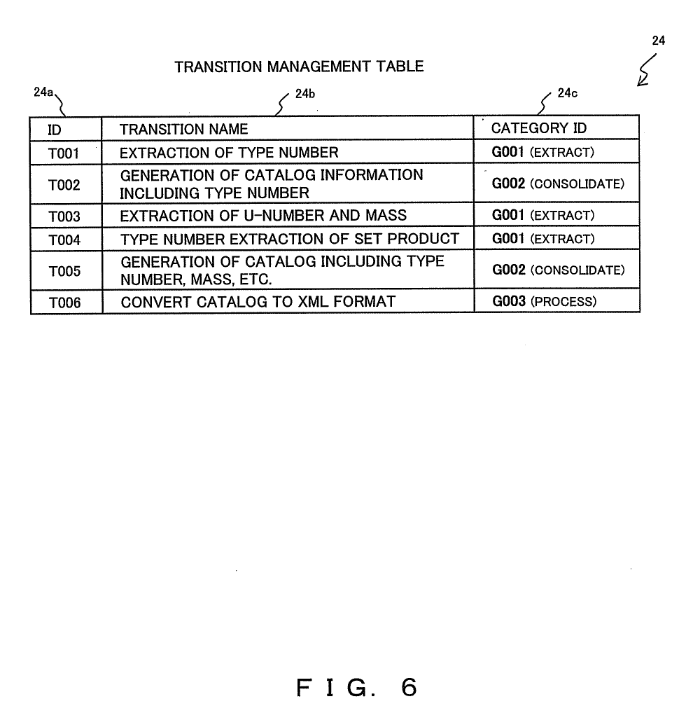

As exemplified by FIG. 6, the transition management table 24 according to the present embodiment stores a transition ID 24a, transition name 24b and category ID 24c by correlating them as one record.

The transition name 24b is a name given to a later described transition 52, while the category ID 24c is set by the category ID 23a of the transition category management table 23 corresponding to the aforementioned transition 52. The transition ID 24a is identifier information given to the aforementioned transition 52.

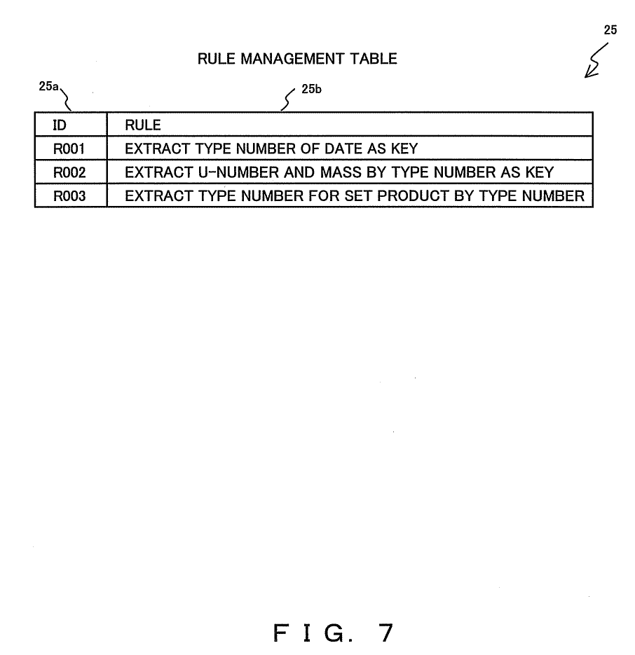

As exemplified by FIG. 7, the rule management table 25 according to the present embodiment stores a rule ID 25a, rule definition 25b, et cetera, by correlating them as rule information.

This rule information describes a rule for the transition 52 handling the information 51.

The rule definition 25b sets a rule for specifying an operation corresponding to the information 51 in a later described transition 52. The rule ID 25a is identifier information for identifying each rule uniquely.

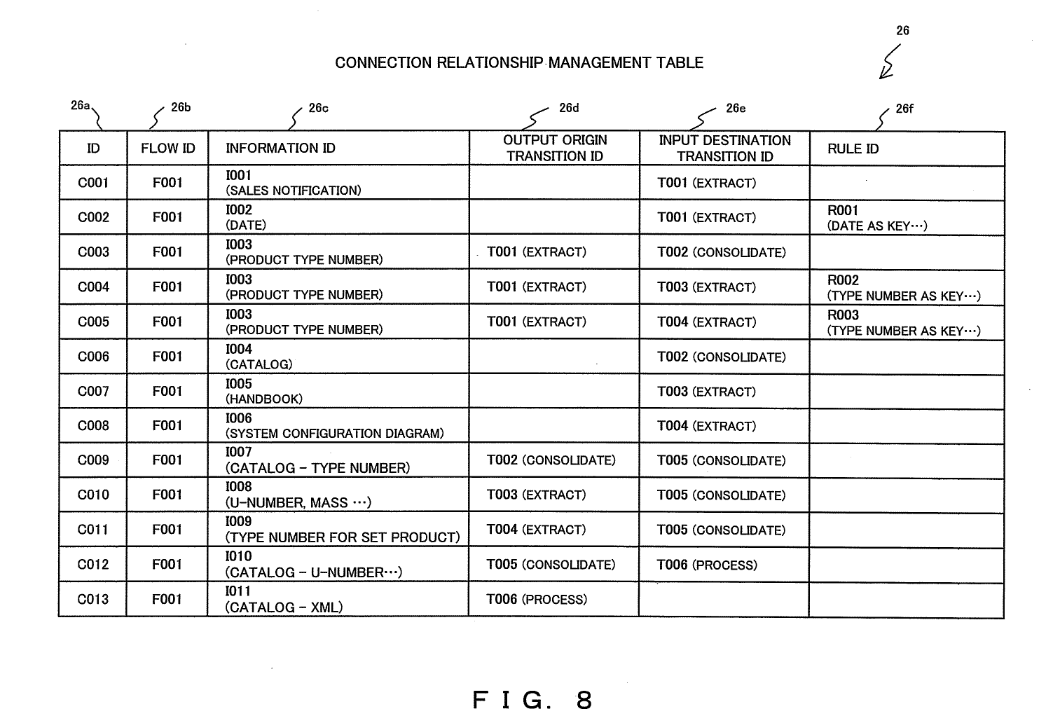

As exemplified by FIG. 8, the connection relationship management table 26 according to the present embodiment stores a connection relationship ID 26a, flow ID 26b, information ID 26c, output origin transition ID 26d, input destination transition ID 26e and rule ID 26f by correlating them as one record.

The connection relationship ID 26a is identifier information assigned to a connection relationship of a later described each piece of information 51 relative to each transition 52.

The flow ID 26b is information for identifying the operation relating to the generated work flow 50 to which the relevant connection relates, and the operation ID 21a of the above flow management table 21 is set to the flow ID 26b.

The information ID 26c is set by the corresponding information ID 22a of the above described information management table 22.

The output origin transition ID 26d is set by the transition ID 24a (of the transition management table 24) for indicating the transition 52 of the output origin of the relevant information 51.

The input destination transition ID 26e is set by the transition ID 24a (of the transition management table 24) for indicating the transition 52 which becomes the output destination of the relevant information 51.

The rule ID 26f is set by the rule ID 25a (of the rule management table 25) for specifying a rule for the transition 52 for processing the relevant information 51.

The present embodiment is configured in such a manner that the flow processing apparatus 11 receives inputs of “information”, “rule”, “transition” and “connection relationship information” as input information and respectively stores, and manages them, in the above described information management table 22 (FIG. 4), rule management table 25 (FIG. 7), transition management table 24 (FIG. 6), and connection relationship management table 26 (FIG. 8).

And there is the flow management table 21 (FIG. 3) disposed for managing information of the created work flow 50.

Note that the transition management table 24 is generated by referring to the transition category management table 23 (FIG. 5), and the connection relationship management table 26 is generated by referring to the information management table 22, rule management table 25 and transition management table 24, all generated by the flow processing program 11a comprised by the flow processing apparatus 11.

Here, the structure of each of the above described series of tables is just an example, and the transition management table 24 may be expanded by adding “operator”, “processing time”, et cetera, for each transition ID 24a, for example.

The flow processing program 11a comprised by the flow processing apparatus 11 outputs the work flow 50 created based on the above described series of tables retained by the storage apparatus 14, and an analysis result relating to the work flow 50 carried out by the aforementioned flow processing apparatus 11 to the output apparatus 13.

[Creation of Work Flow]

Next, how the flow processing program 11a comprised by the flow processing apparatus 11 creates a work flow 50 based on the connection relationship management table 26, information management table 22, rule management table 25 and transition management table 24, all of which are defined by the respective pieces of information is described.

The present embodiment exemplifies an analysis relating to an operation of making a catalog of a server equipment that is the product.

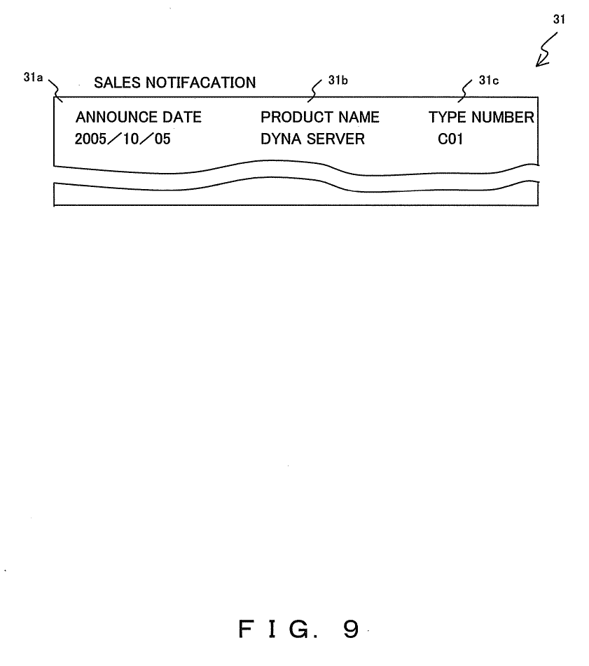

FIG. 9 shows sales notification information 31 as an example of the information 51 relating to a creation of the work flow 50 according to the present embodiment.

The sales notification information 31 includes information such as an announcement date 31a, product name 31b and type number 31c.

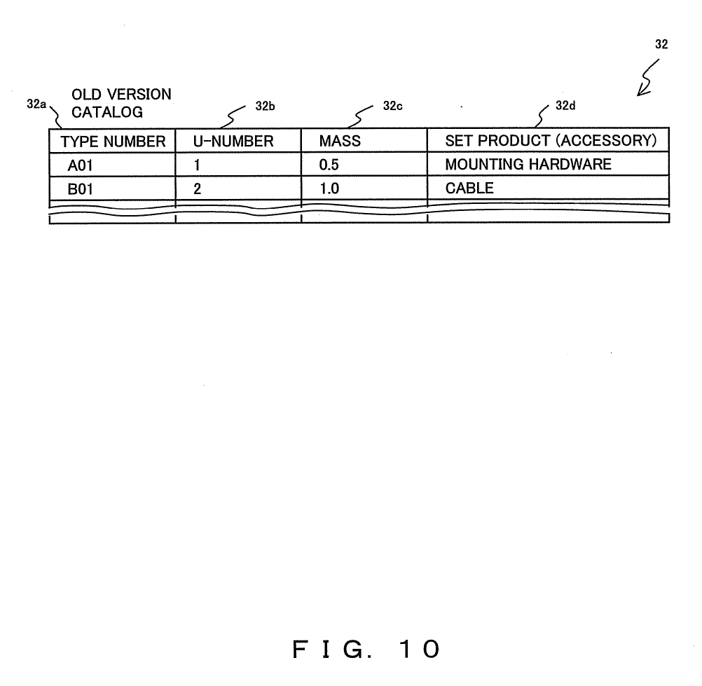

FIG. 10 shows an old version catalog 32 as an example of the information 51 relating to a creation of the work flow 50 according to the present embodiment.

The old version catalog 32 stores a type number 32a, U-number 32b, mass 32c and set product 32d by correlating them.

The type number 32a is identifier information for the server equipment that is a product.

The U-number 32b is information for indicating the size in the height direction of a rack mounting type server equipment.

The mass 32c indicates the mass of the server equipment that is a product.

The set product 32d indicates information relating to an accessory attached to the server equipment that is a product.

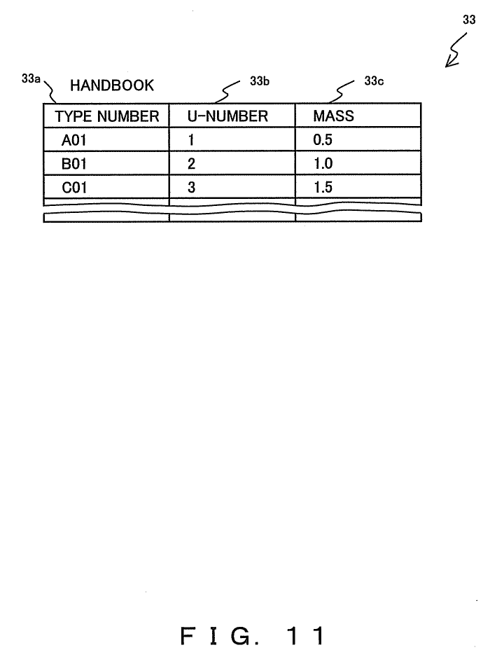

FIG. 11 shows a content of a handbook 33 as an example of the information 51 relating to a creation of the work flow 50 according to the present embodiment.

The handbook 33 stores information of a U-number 33b and mass 33c by correlating them for each type number 33a.

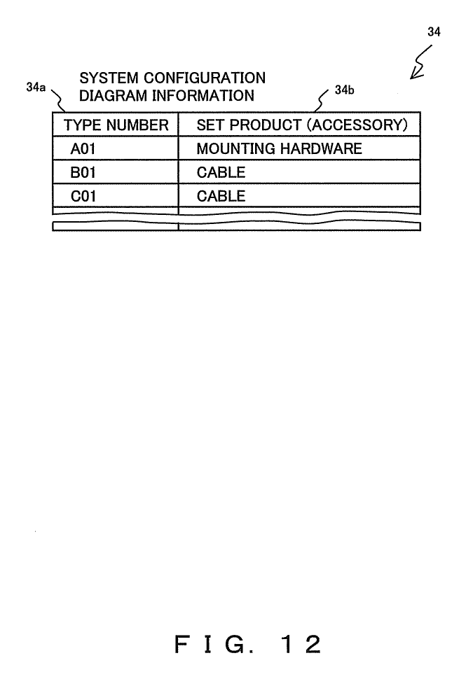

FIG. 12 exemplifies a content of system configuration diagram information 34 as an example of the information 51 relating to a creation of the work flow 50 according to the present embodiment.

The system configuration diagram information 34 stores a type number 34a and set product 34b by correlating them.

The system configuration diagram information 34 stores information of the accessory necessary for mounting the server equipment, which is a product indicated by the type number 34a, to a rack.

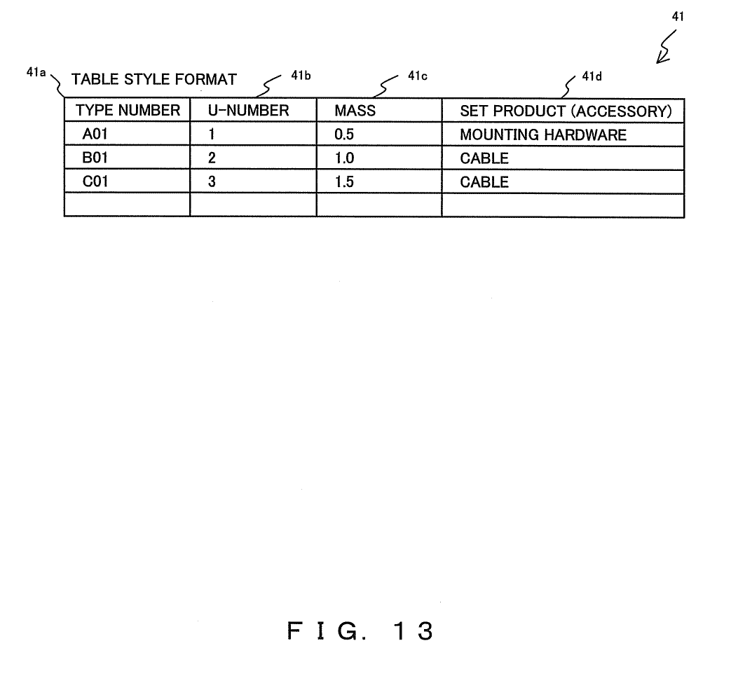

FIG. 13 is a conceptual diagram exemplifying an output format of information for obtaining a final product 53 dealt with by an operation according to the present embodiment. The present embodiment is configured to output in a table style format 41 to obtain the final product 53.

The table style format 41 comprises a type number 41a, U-number 41b, mass 41c and set product 41d.

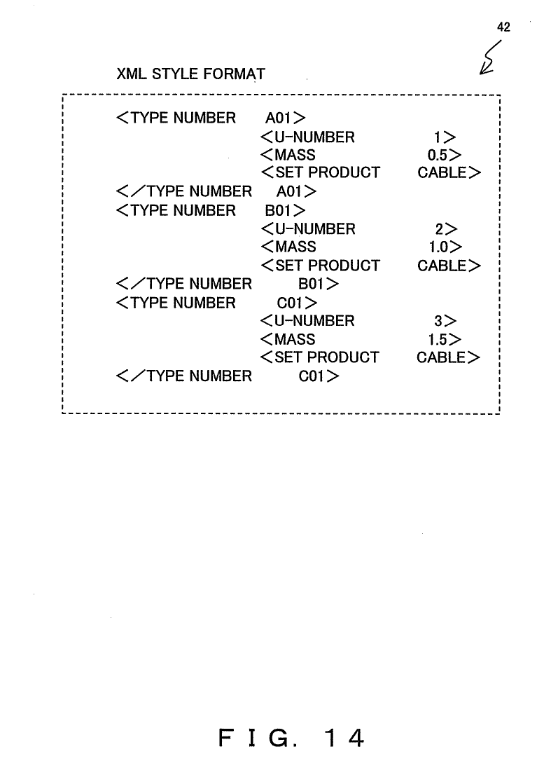

FIG. 14 further exemplifies an XML style format in the case of outputting, to an XML form, the final product 53 dealt with by the operation according to the present embodiment.

FIG. 1 shows a work flow 50 expressing an operation with “information 51”, “transition 52” and “final product 53”.

FIG. 1 exemplifies the case of obtaining a catalog in the XML style format 42 as the final product 53 by using the information of sales notification information 31, old version catalog 32, handbook 33, system configuration diagram information 34, et cetera, as the input information 51, all of which are externally specified.

The work flow 50 shown by FIG. 1 created by the flow processing program 11a according to the present embodiment focuses only on the information 51 dealt with by the operation, thereby enabling a consolidation of the information 51 and an easy comprehension of a subordinate and superior relationship thereof.

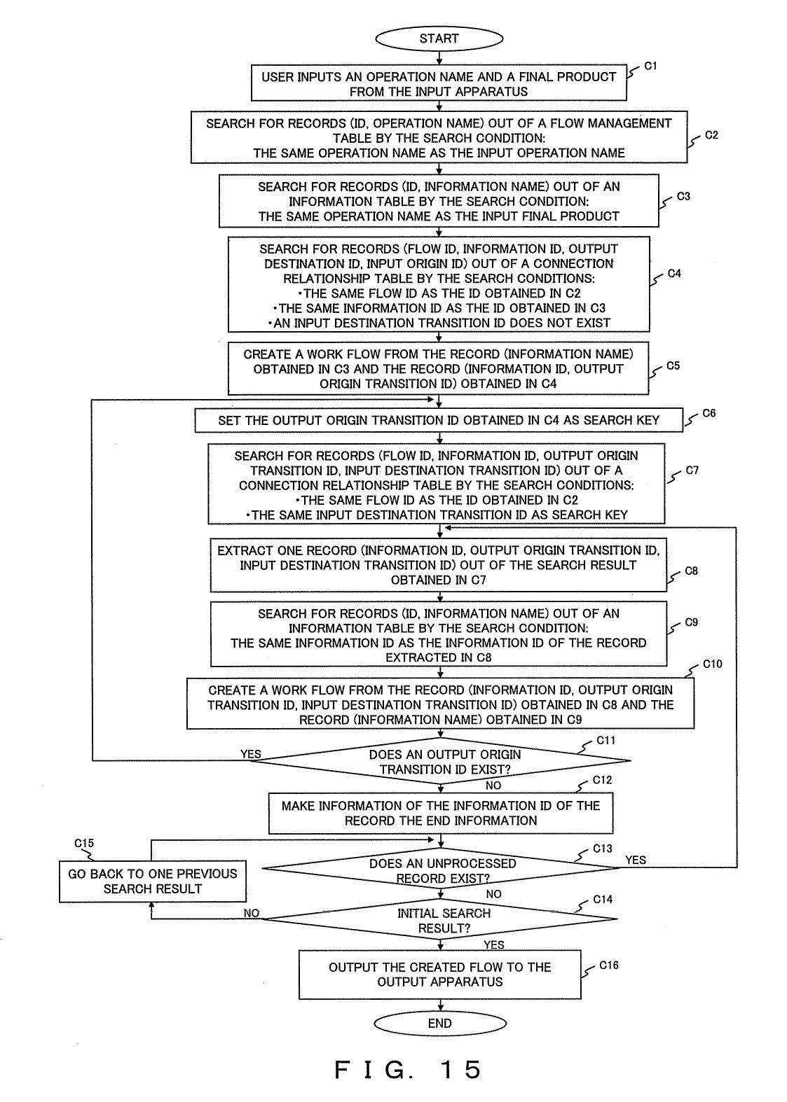

Let a flow of processing carried out by the flow processing program 11a for creating the flow shown by FIG. 1, be described while referring to the flow chart shown by FIG. 15.

First information is received on an operation name and a final product 53 from an operator by way of the input apparatus 12 (step C1; simply “C1” hereinafter).

Next a record is searched for having the same operation name 21b as the input operation name from of the flow management table 21 (C2).

Next a record is searched for having the same information name as the inputted final product 53 from of the information management table 22 (C3).

Next a record is searched for satisfying all of the following conditions J1 through J3 from of the connection relationship management table 26 (C4):

J1: the same flow ID 26b as the ID (i.e., the operation ID 21a) obtained in the step C2;

J2: the same information ID 26c as the ID (i.e., the information ID 22a) obtained in the step C3; and

J3: non-existence of an input destination transition ID 26e.

Next a flow is created from the record obtained in the step C3 and the one obtained in the step C4 (C5).

Next the output origin transition ID 26d of the record obtained in the step C4 (C6) is set as the search key.

Next a record is searched for satisfying all conditions J21 and J22 from of the connection relationship management table 26 (C7):

J21: the same flow ID 26b as the ID (i.e., the operation ID 21a) obtained in the step C2; and

J22: the same input destination transition ID 26e as the search key.

Next one record is extracted from the search result obtained in the step C7 (C8).

Next the information management table 22 is searched, for a record having the same information ID 22a as the information ID 26c of the record which is obtained in the step C8 (C9).

Next a flow is created from the record obtained in the step C8 and the one obtained in the step C9 (C10).

Next it is judged whether or not an output origin transition ID 26d exists in the record obtained in the step C8 (C11).

If the output origin transition ID 26d exists, repeat the steps C6 through C10 until the result record non-existent is obtained.

If the output origin transition ID 26d does not exist, the judgment is that the information of the information ID 26c of the record is not the one generated by the operation, and accordingly the search is stopped (C12).

Next it is judged whether or not an unprocessed record exists in the search result (C13).

If the unprocessed record exists, repeat the steps C8 through C12 until all the records are processed.

If the unprocessed record does not exist, judge whether or not the current search result is the search result of the initial step C7 (C14).

If it is not the first search result, return to the search result one-step previous (C15), followed by repeating the steps C13 and C14.

If on the other hand it is the first search result, output the created work flow to the output apparatus 13 as the work flow 50 (C16).

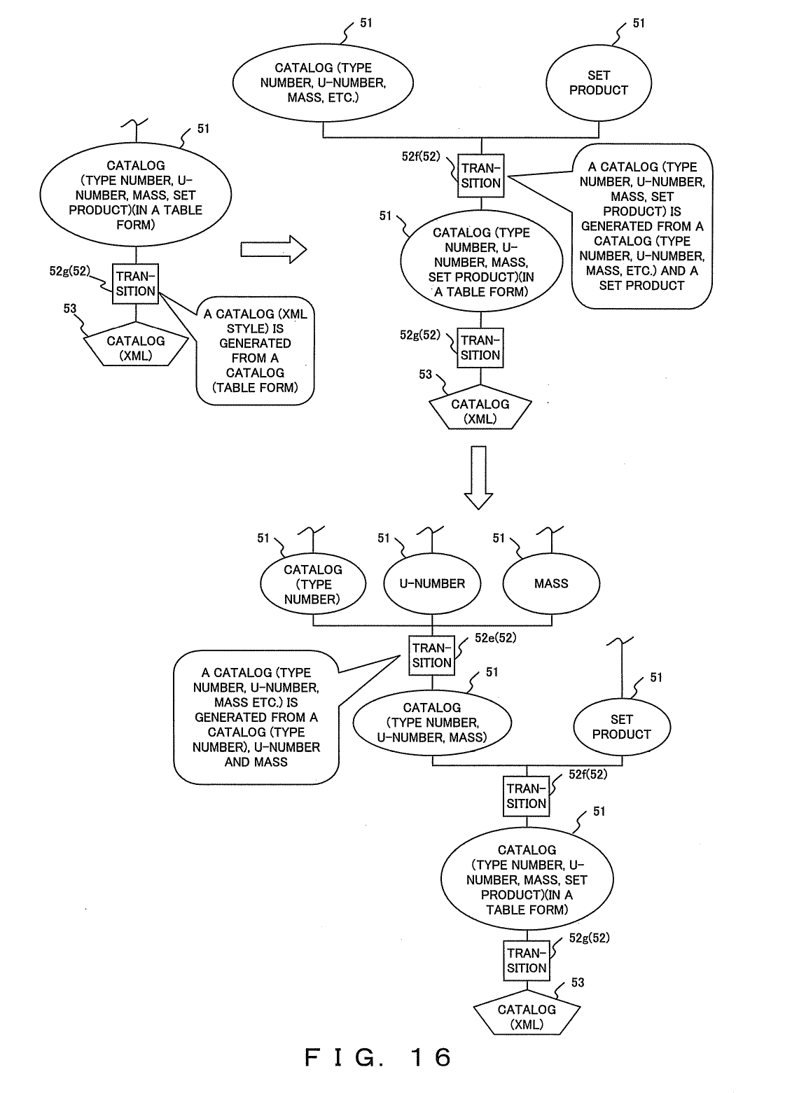

The processing according to the above described flow chart builds up the work flow 50 shown by FIG. 1 in a manner of proceeding upstream starting from the final product 53 as shown by FIG. 16.

The operation expressed by the work flow 50 shown by FIG. 1 is as follows:

That is, the first is to extract, by the transition 52a, a type number 31c of a product announced on the day identified by the information 51 (i.e., “new date”) which is specified by the input apparatus 12 from the sales notification information 31.

Next is to obtain the information 51 which is an addition of the type number 32a to the old version catalog 32 by the transition 52b starting therefrom, based on the type number 31c. And to obtain the information 51 of the U-number 33b and mass 33c from the handbook 33 by the transition 52c. And to obtain the information 51 of the set product 34b from the system configuration diagram information 34 by the transition 52d.

Furthermore, the information 51 of the type number 32a and that of the U-number 33b and mass 33c are consolidated, by the transition 52, to one piece of information 51 which constitutes a part of a catalog as the final product 53.

The above is followed by the information 51 of the type number 32a, U-number 33b and mass 33c, which are consolidated by the transition 52e, absorbing, by the transition 52f, the information 51 of the set product 34b output from the above described transition 52d, thus becoming the information 51 of the catalog shown in the table style format 41.

Then, the table style format 41 is converted to the XML style format 42 by the XML conversion processing of the transition 52g, resulting in the catalog in the XML style format 42 becoming the final product 53.

The operation described by the work flow 50 shown by FIG. 1 is automatically created in such a manner as to proceed upstream starting from the final product 53 as a final product to the side of the sales notification information 31 as shown by the above described FIG. 16.

[A Method for Analyzing an Operation by Terminal Information]

The next description is of a system for analyzing an operation by the number of pieces of information which are not generated by the operation.

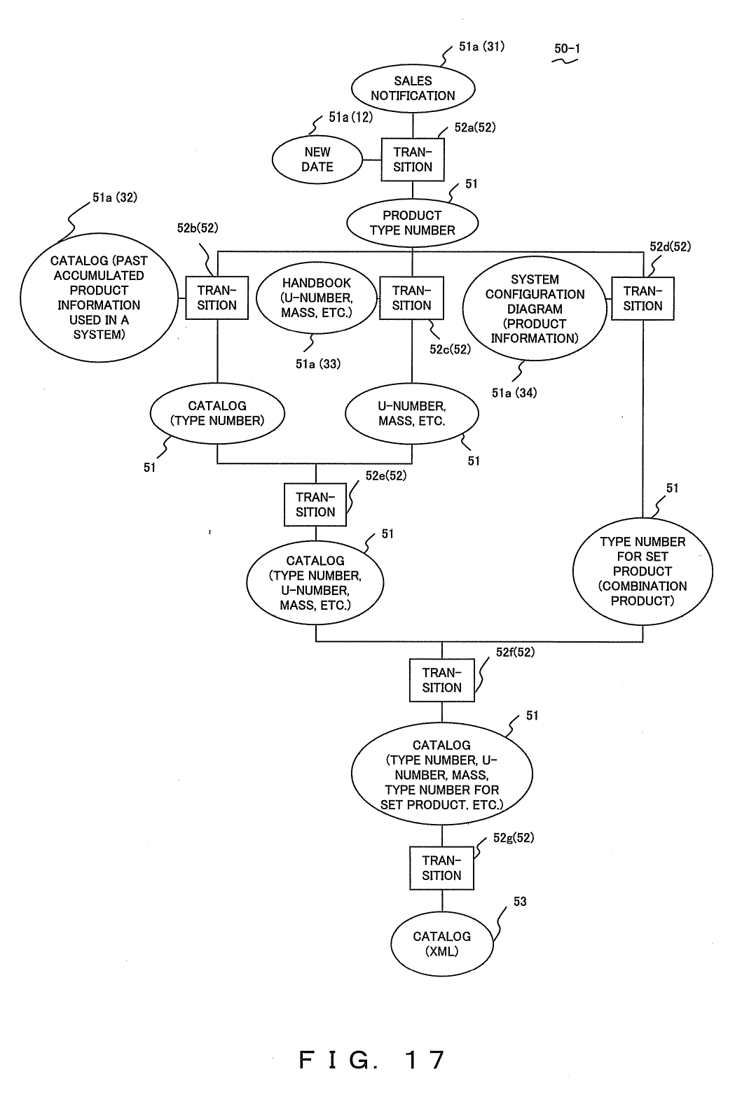

FIG. 17 shows a work flow 50-1 which expresses an operation by “information 51”, “transition 52” and “final product 53” and also indicates “information that is not generated by the operation (i.e., terminal information 51a hereinafter)” distinguishably.

In the work flow 50-1 created in the present embodiment as shown by FIG. 17, the terminal information 51a is information obtained external to the operation (as per the work flow 50-1). This means that an external dependency of the work flow 50-1 increases with the amount of the terminal information 51a, hence it is prone to an influence of other operations.

Also, the externally dependent terminal information 51a cannot be controlled by operations indicated by the work flow 50-1 causing a problem at the time of obtaining it. Therefore, it is necessary to reduce the external dependencies or reduce the number of pieces of terminal information 51a in order to improve a reliability of the work flow 50-1.

In order to create the work flow 50-1 shown by FIG. 17 according to the present embodiment, the information 51 obtained by the processing of the step C12 in the flow chart shown by FIG. 15 is the terminal information 51a. Therefore, it is possible to display the terminal information 51a distinguishably by changing display colors thereof in the aforementioned step C12.

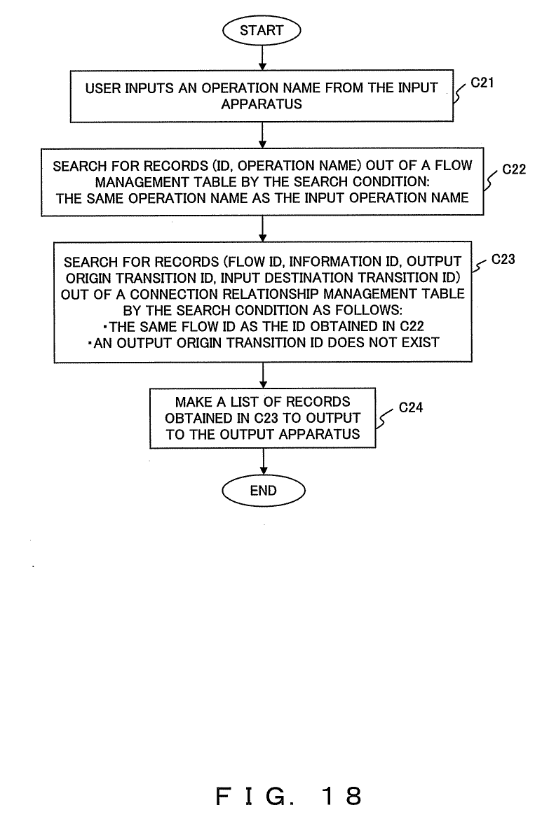

Let the processing for obtaining a list of terminal information 51a, be described as another method using the flow chart shown by FIG. 18.

First an operation name is received from an operator by way of the input apparatus 12 (C21).

Next a record is searched for having the same operation name 21b as the input operation name from the flow management table 21 (C22).

Next a record is searched for satisfying both the following conditions J31 and J32 from the connection relationship management table 26 (C23):

J31: the same flow ID 26b as the ID (i.e., an operation ID 21a) obtained in the step C22; and

J32: an output origin transition ID 26d does not exist.

This is because the terminal information 51a is information obtained external to the work flow 50, information in which an output origin transition ID 26d for indicating an output from other transitions does not exist can be judged as the terminal information 51a.

Next is to generate, and output to the output apparatus 13, a list of terminal information 51a from the record obtained in the step C23 (C24).

[A Method for Analyzing an Operation by Categorizing Transitions to a Limited Number]

The next description is of an example of simplifying an analysis of an operation by categorizing transitions 52 into a limited number of categories.

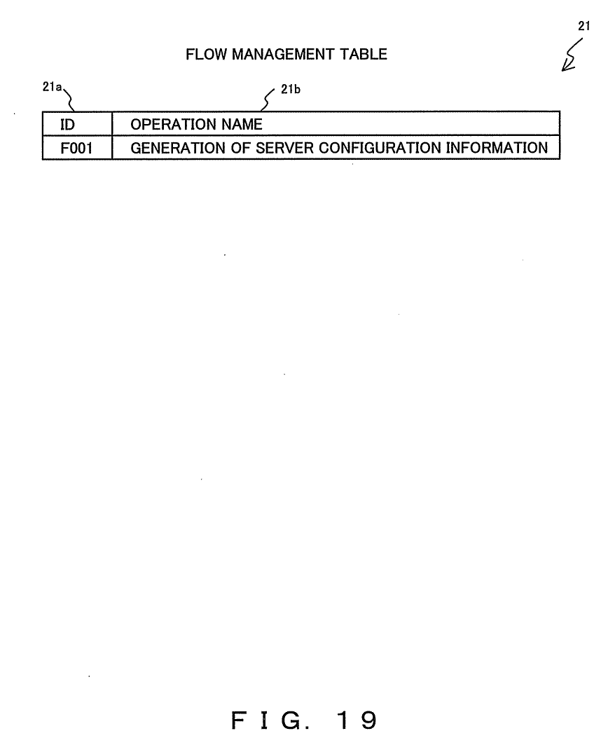

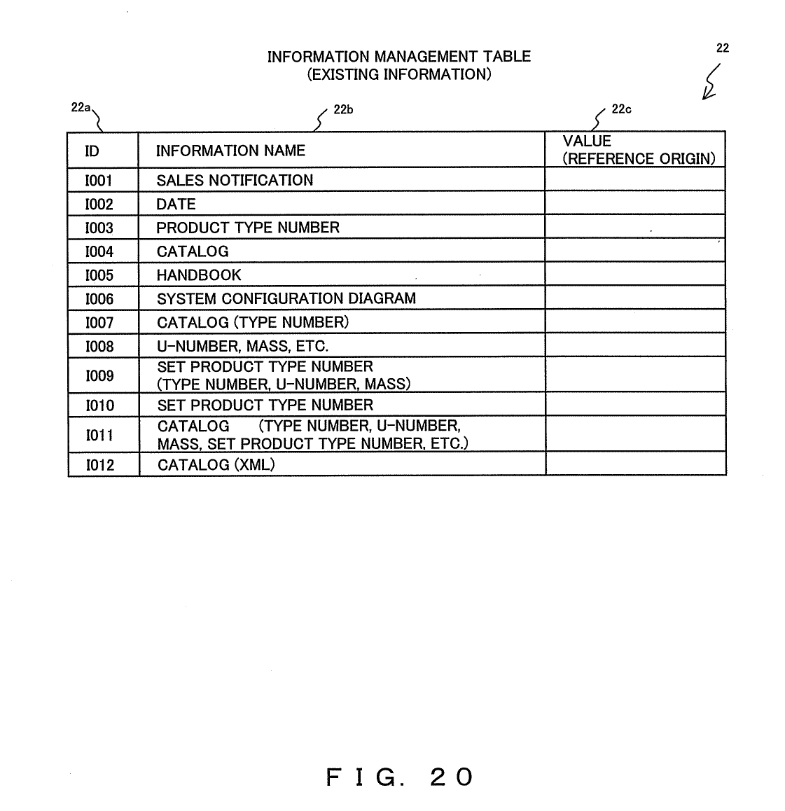

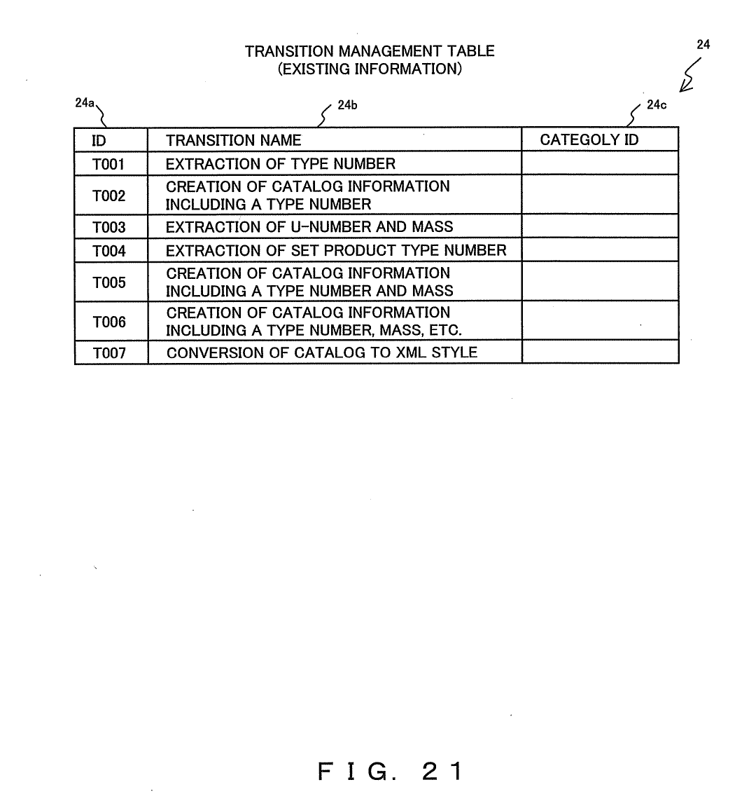

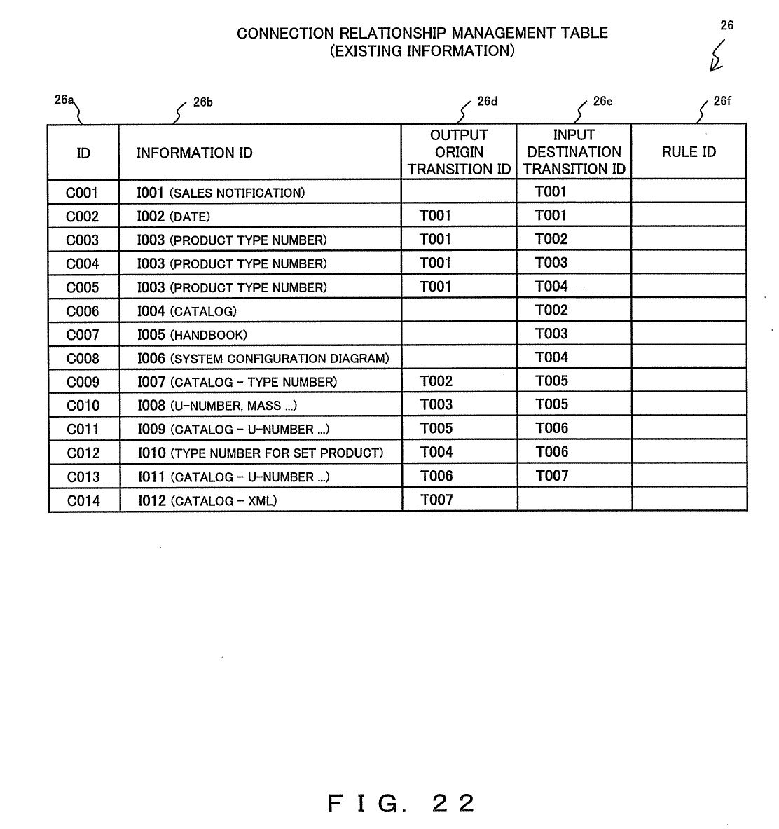

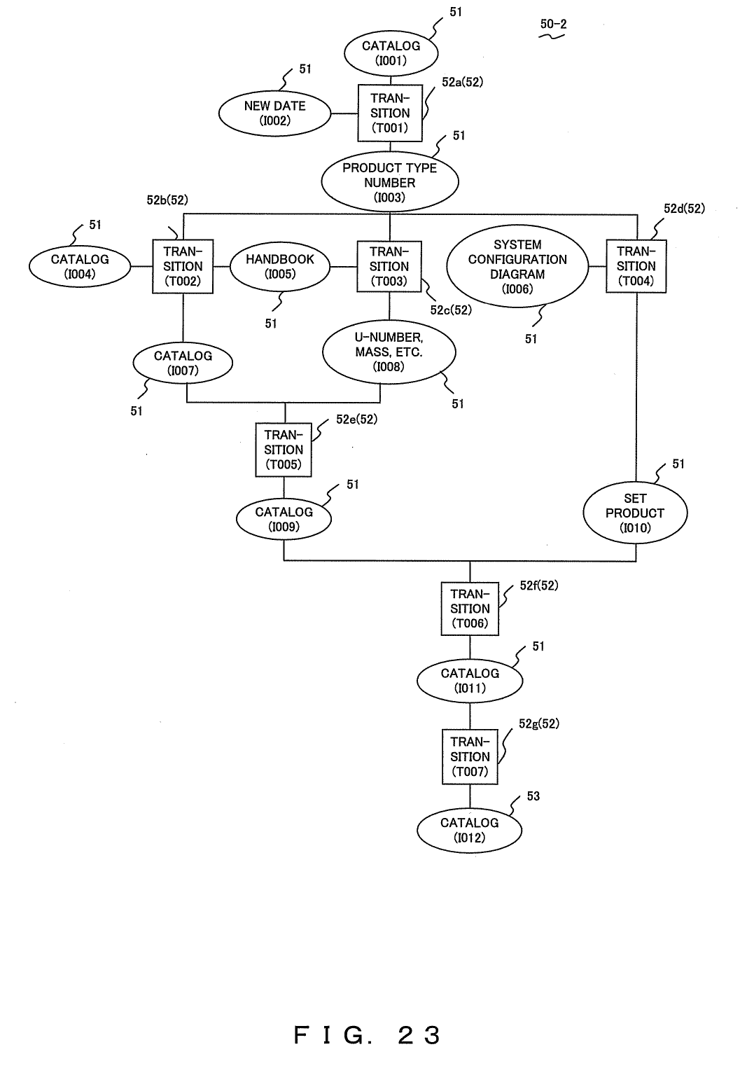

Let it be assumed that all pieces of information, that is, a flow management table 21, information management table 22, transition management table 24 and connection relationship management table 26 which are necessary for creating a work flow are all available as shown by FIGS. 19, 20, 21 and 22, respectively, and that the flow processing apparatus 11 has displayed a work flow 50-2 expressed by information 51 and transition 52, as exemplified by FIG. 23, based on the aforementioned pieces of information.

It is also assumed that a user tries to categorize the transitions to “extraction”, “consolidation” and “processing” for example.

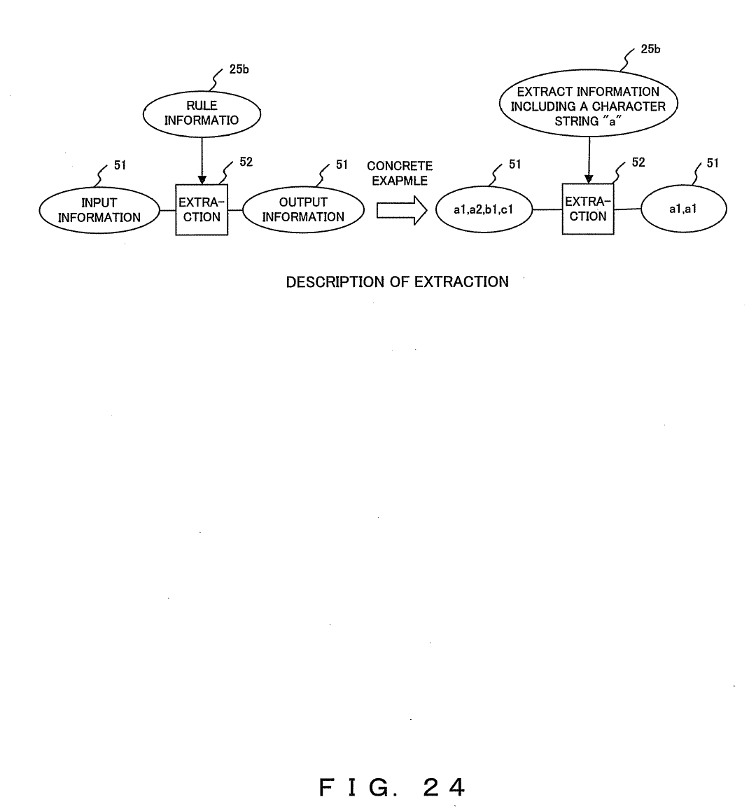

Here, the “extraction” is defined as a handling for extracting information from the input information according to the rule information (which is a description of a rule for a handling of information) of the rule management table 25 as exemplified by FIG. 24.

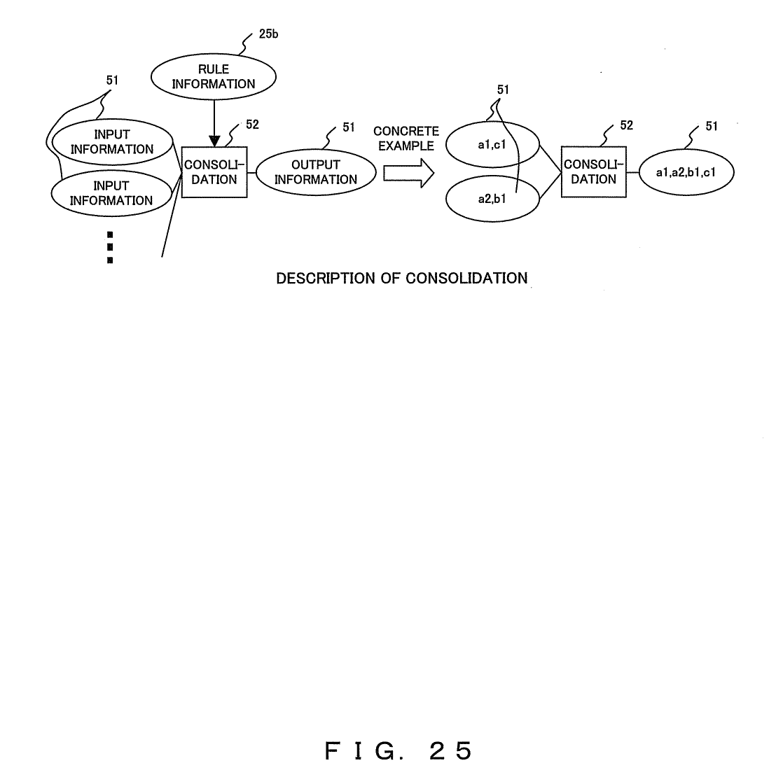

The “consolidation” is defined as a handling for summing up plural pieces of input information to one piece thereof as exemplified by FIG. 25. The “consolidation” sometimes has rule information for a consolidation.

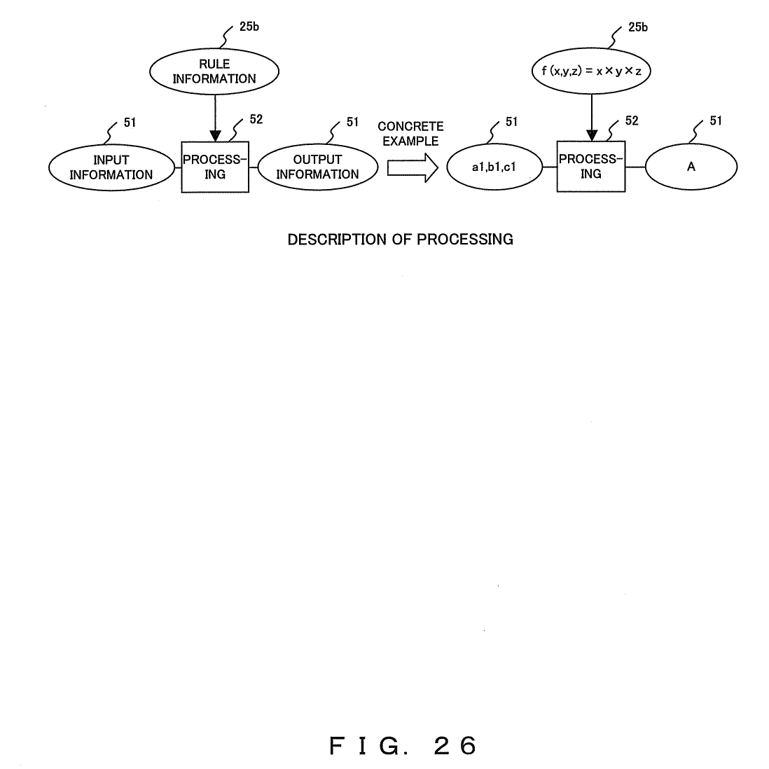

The “processing” is defined as a handling for creating another information 51 by processing input information 51 based on rule information as exemplified by FIG. 26.

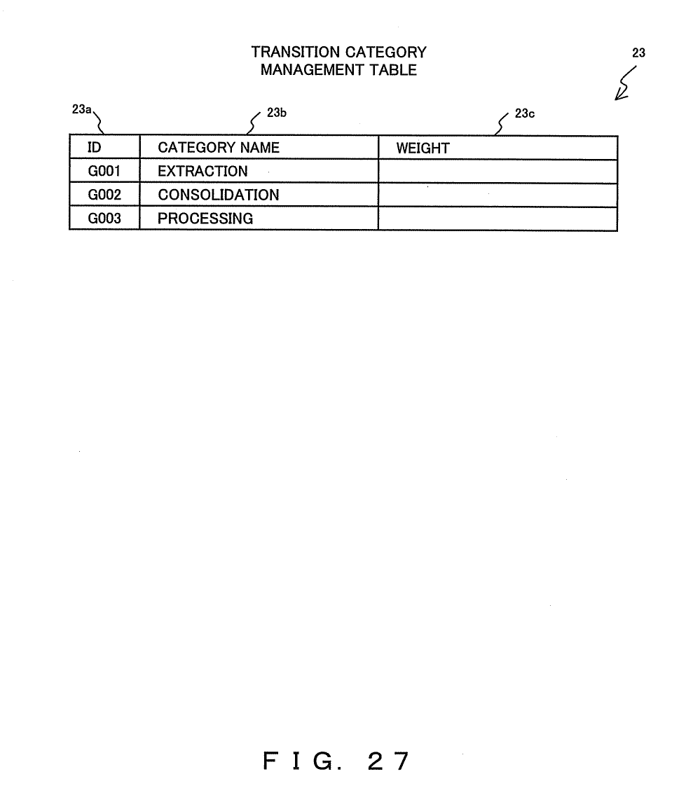

And the transitions 52 categorized by the user are stored by the transition category management table 23, as shown by FIG. 27, in which there are the category ID 23a of G001 through G003 and the category names 23b respectively corresponding thereto.

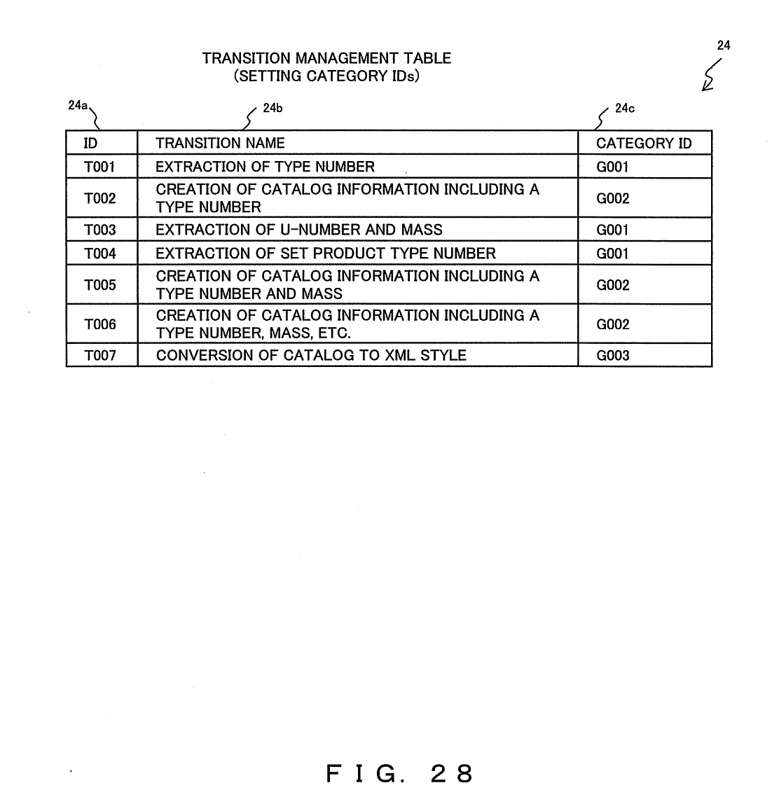

If the user allocates the categories shown by the above described FIG. 27 to each transition 52 shown by FIG. 23 through the input apparatus 12 in this event, then the above noted G001 through G003 are allocated to the applicable category IDs 24c of the transition management table 24 exemplified by FIG. 28.

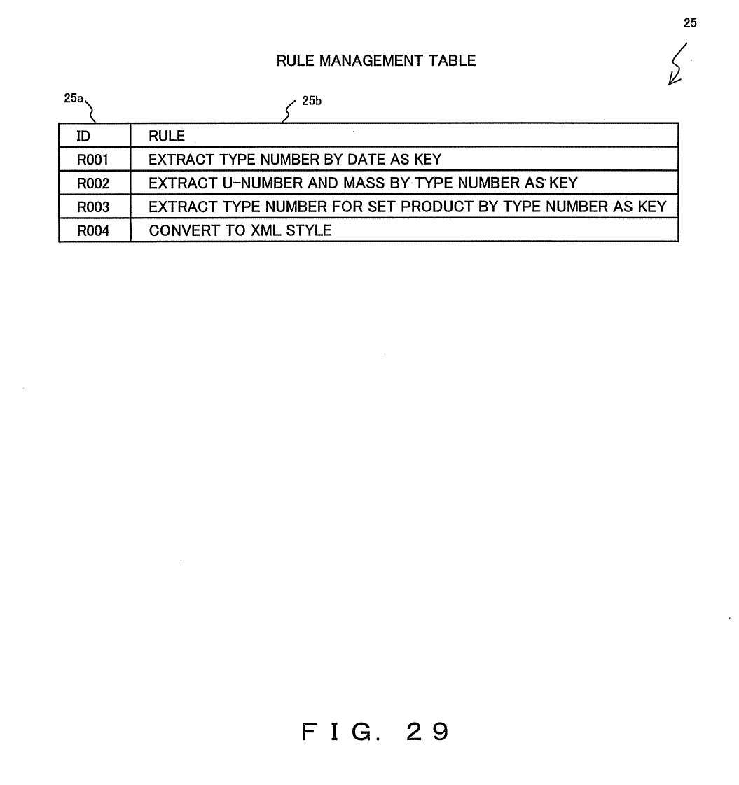

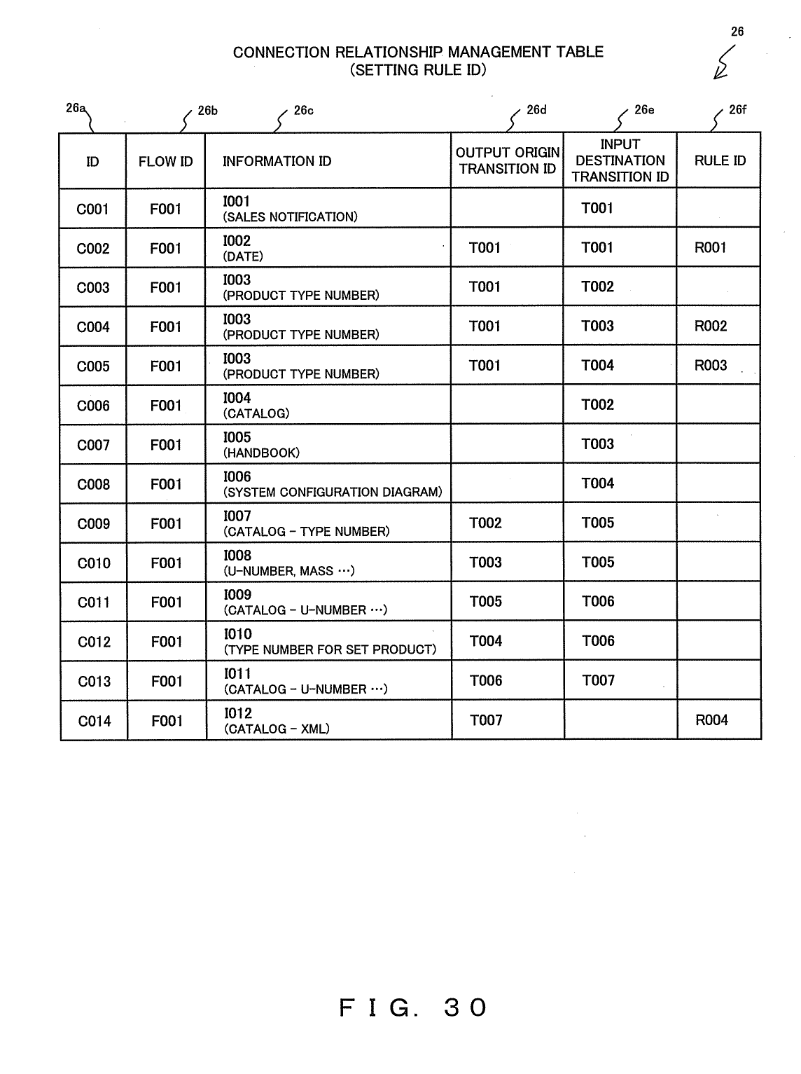

And, if a rule is required when categorizing the transitions 52, a rule table stores IDs, e.g., R001 through R004, and rules a lá FIG. 29. Additionally, in order to correlate with a transition being applied by the rule, the rule IDs 25a allocated in the rule management table 25 are registered in the rule ID 26f of the connection relationship management table 26 as shown by FIG. 30.

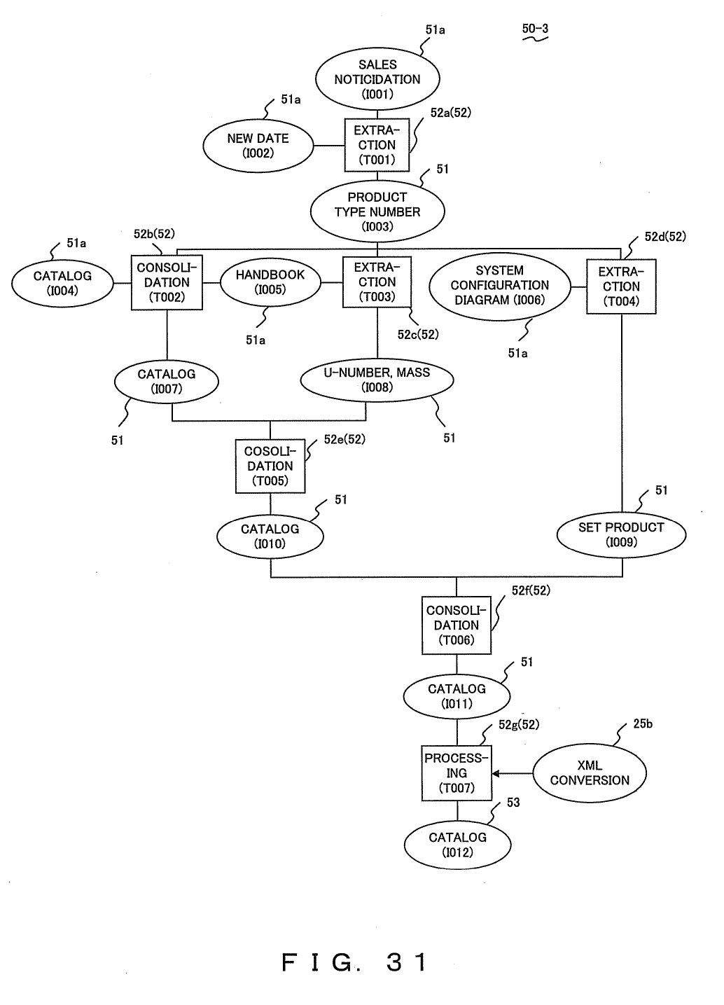

Having gone through the above described processes, the flow processing apparatus 11 obtains the necessary information from the respective tables, thereby being capable of creating graphic information on a work flow 50-3 with the transitions 52 being categorized to a limited number as exemplified by FIG. 31.

Note that FIG. 31 shows an example of obtaining the final product 53 by using the information of an “XML conversion” as a rule definition 25b in the transition 52g where the transition ID 24a is “T007” and converting catalog data from the table style format 41 shown by FIG. 13 to the XML style format 42 shown by FIG. 14.

By the above described processing of categorizing operation contents of the information 51 which are carried out in the respective transitions 52 into a limited number of categories, thereby enabling a simplified expression of the work flow 50-3, hence making it possible to easily analyze the operation by referring to the work flow 50-3.

[A Method for Analyzing an Operation from the Number of Transitions]

The next description is of a system for analyzing an operation based on the number of transitions.

Now, let it be assumed that the user instructs the flow processing apparatus 11 to analyze the work flow 50-3 shown by FIG. 31 by the number of transitions 52.

The flow processing apparatus 11 sums up, and displays, the number of respective transitions 52 utilized by the specified workflow 50-3 from the connection relationship management table 26 (FIG. 30), category ID 24c of the transition management table 24 (FIG. 28), and transition category management table 23 (FIG. 27).

The respective numbers are three for “extraction”, three for “consolidation” and one for “processing” in the example of FIG. 31. The user, having seen the result indicating the consolidation occupying almost a half of the transitions 52, is enabled for an analysis such as a reduction in the number of transitions 52 by gathering the consolidation handling in one place.

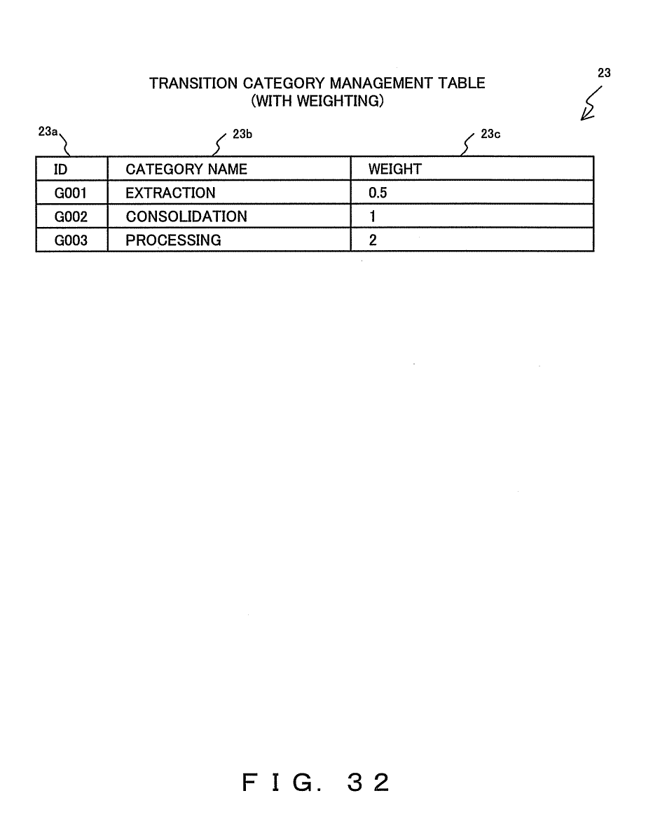

And the user is enabled to set a weight 23c for each category as indicators of a handling time, and degree of a handling difficulty, of information, when setting category of the transitions 52 to the transition category management table 23, as shown in FIG. 32, and therefore obtain a highly accurate analysis result.

[A Method for Analyzing an Operation from the Number of Transitions per Path]

Let a method for analyzing an operation by summing up the number of transitions 52 per path within a work flow 50, be described.

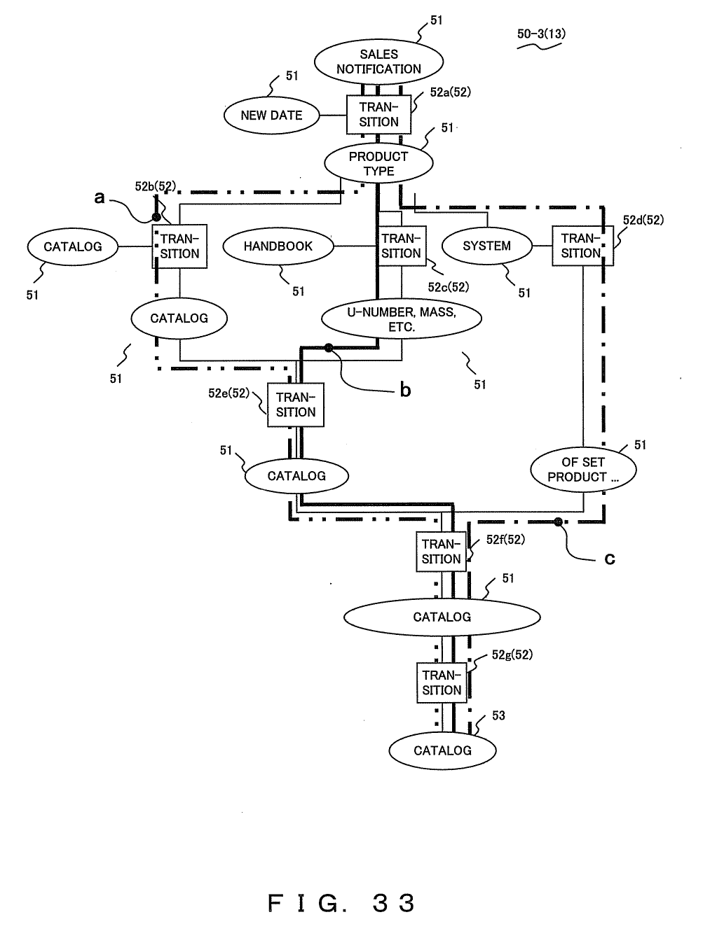

FIG. 33 is a display example of a work flow 50-3 in an operation for obtaining a “catalog” as a final product 53.

When the user instructs a “path analysis”, the flow processing apparatus 11 searches all paths terminating at the final product 53 and displays a result summing the number of transitions 52 per path based on information stored by the connection relationship management table 26.

In this event, the search maybe limited to a path connecting the final product 53 with the information by the user specifying the information as the start point of the path.

In the example shown by FIG. 33, the detected are three paths, i.e., paths “a”, “b” and “c”, connecting the “catalog” as the final product 53 with the information 51 (i.e., sales notification”) as the start point.

The path “a” includes five transitions 52, i.e., transitions “52a”, “52b”, “52e”, “52f” and “52g”.

The path “b” includes five transitions 52, i.e., transitions “52a”, “52c”, “52e”, “52f” and “52g”.

The path “c” includes four transitions 52, i.e., transitions “52a”, “52d”, “52f” and “52g”.

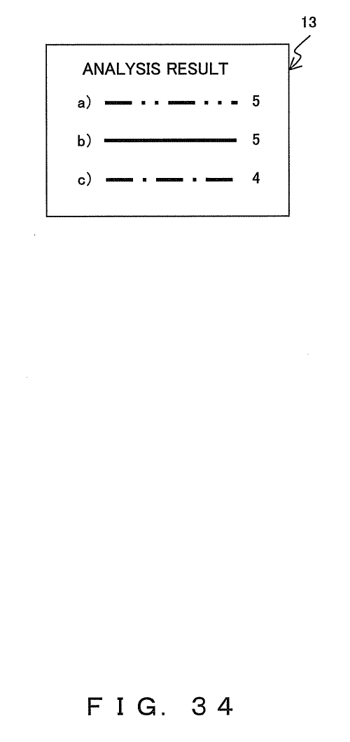

And the number of transitions 52 that each path possesses is presented as an analysis result by way of the output apparatus 13 as shown by FIG. 34. This result makes it clear as to which path of the work flow 50-3 possesses many transitions, enabling an easy detection of the part for improving such as by parallelization.

That is, a required time (i.e., a lead time) from inputting a sales notification information 31 (i.e., information 51) to outputting the final product 53 can be shortened by selecting the paths “a” and “b” with the larger number of transition 52 steps as the subject of parallelization.

[A Method for Analyzing an Operation from a Degree of Multiplexing of a Sub-flow]

The next description is of a method for analyzing an operation by summing up a degree of multiplexing of a sub-flow. Here, a sub-flow is defined as a (partial) flow for generating a certain piece of information.

As the user selects a transition 52 for a start point of an analysis and instructs an “analysis of a degree of multiplexing”, the flow processing apparatus 11 detects a sub-flow connected to the specified transition 52 based on information stored by the connection relationship management table 26.

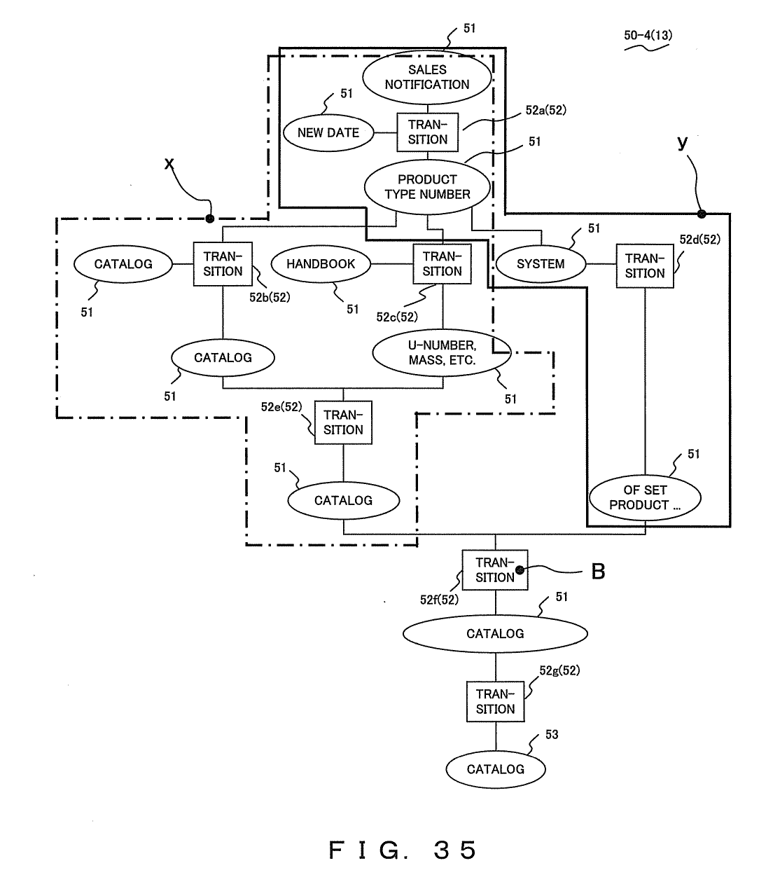

In the example of a work flow 50-4 shown by FIG. 35, two sub-flows, i.e., a sub-flows x and y, with the transition 52 indicated by “B” as the start point are detected for example.

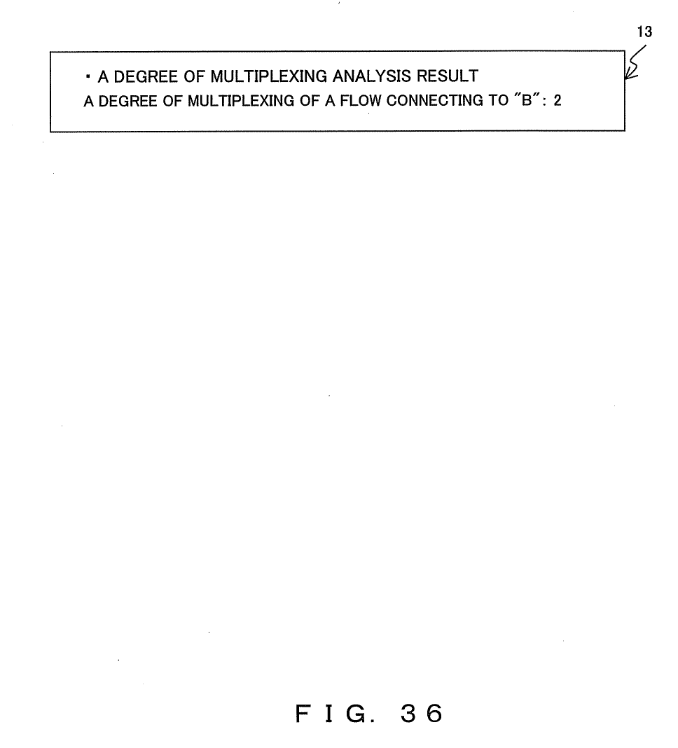

Then, a result that the degree of multiplexing for this part is two is presented to the user by way of the output apparatus 13 as a result of analyzing a degree of multiplexing as shown by FIG. 36.

This enables the user to understand which part of the work flow has a large degree of multiplexing and accordingly identify the parts in need of additional resources.

For example, allocation of more human resources to the part where a degree of multiplexing is large makes it possible to take the load off each operator and/or attempt to shorten a lead time.

[A Method for Analyzing an Operation from a Congestion Point of Information]

Next, as the user instructs a “congestion analysis”, the flow processing apparatus 11 displays a result of summing the number of transitions 52 possessed by each sub-flow based on information stored by the connection relationship management table 26.

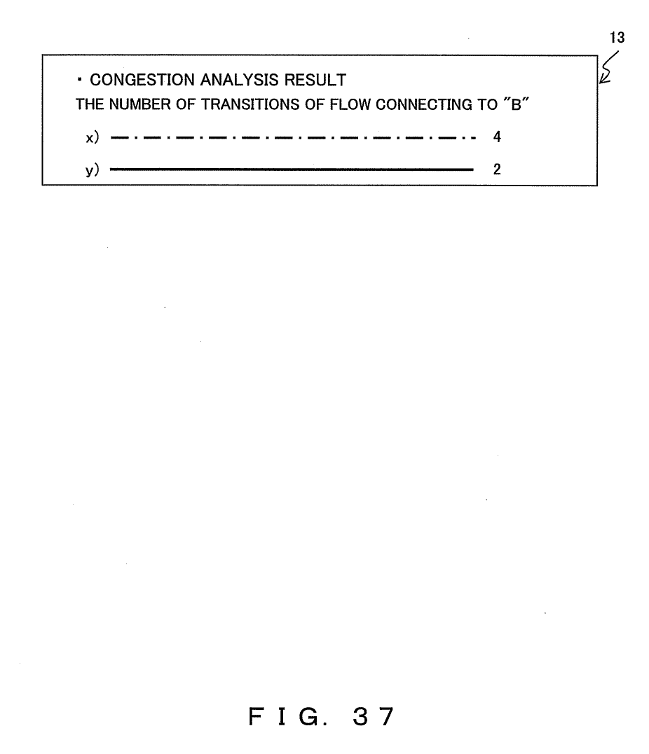

In the example of a work flow 50-4 shown by FIG. 35, the number of transitions, i.e., four for the sub-flow x (i.e., the transitions 52a, 52b, 52c and 52e) and two for the sub-flow y (i.e., the transitions 52a and 52d) are displayed for the user as the congestion analysis result by way of the output apparatus 13 as shown by FIG. 37.

In this case, it is understood that the sub-flow x needs more transition 52 so that there is a possibility of congestion, i.e., waiting for processing in the sub-flow x at the transition 52 of “B”.

Therefore, a countermeasure can be provided by allocating more manpower to the transition 52 of the sub-flow x (i.e., the transitions 52a, 52b, 52c and 52e), shortening a lead time by parallelization, et cetera.

Note that an alternative configuration may be such that the “congestion analysis” shown by FIG. 37 is carried out simultaneously with the “degree of multiplexing analysis” shown by FIG. 36 for displaying both results in the same screen of a display 13a comprised by the output apparatus 13.

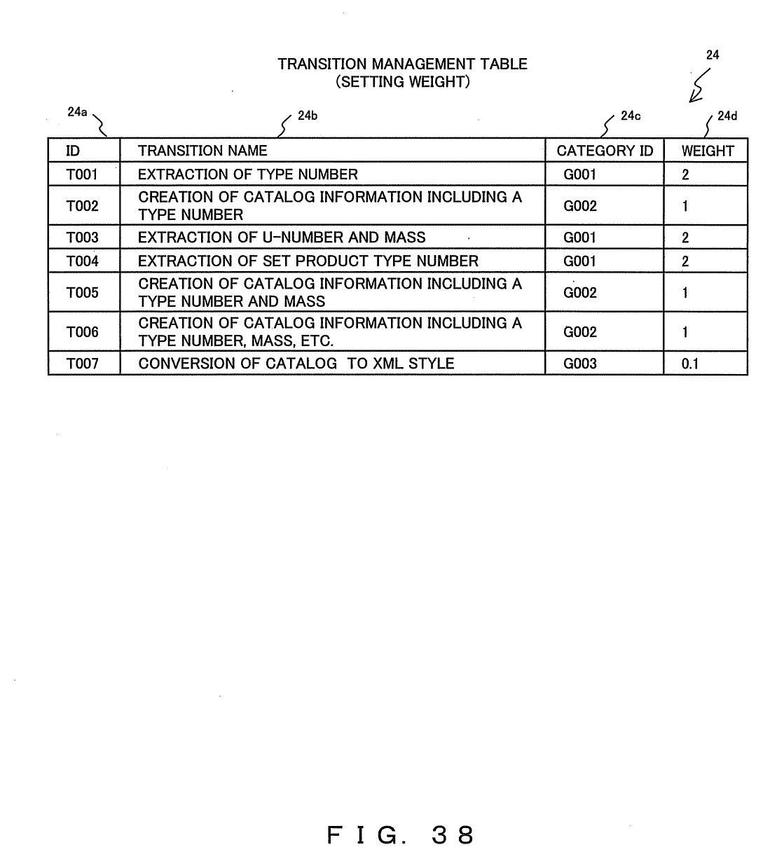

In this event, a weight 24d can also be set as an indicator of a handling time or degree of handling difficulty of information for each transition by way of the transition management table 24 as shown by FIG. 38 so as to enable an acquisition of a highly accurate analysis result.

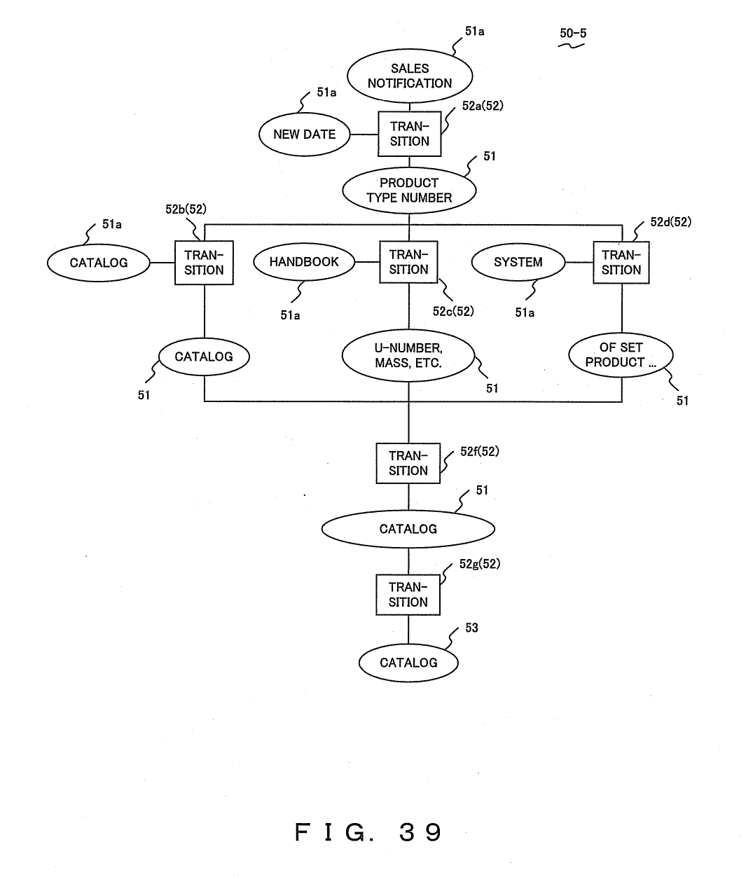

FIG. 39 shows an example of the above described analysis result being reflected on a work flow 50 to improve it.

That is, shown here is a work flow 50-5 consolidating the transition 52e (T005) and transition 52f (T006), which are categorized as “consolidation” in the work flow 50-3 exemplified by FIG. 31, to one new transition 52f.

As a result of the above, the number of transitions 52 has been reduced from seven to six, with the maximum number of steps decreasing from five to four in the work flow 50-5.

Here, the number of steps means the position of a transition 52, where the number thereof passing in the direction toward the final product 53 starting from the information 51 as the startpoint (the sales notification information 31 in this case), is the same, within the work flow 50.

A reduction of the number of the above described steps enables a shortening of time (i.e., a lead time) required for obtaining the final product 53.

Note here that the present invention allows of course various changes within the scope thereof, in lieu of being limited by those configurations exemplified in the above described embodiments.

The present invention enables an analysis and evaluation of an operation easily without requiring a cumbersome processing such as redefinition of processes constituting the operation.

Also enabled is a prevention of degradation in an accuracy or reliability of operation analysis caused by an overlooked definition of information.

Also enabled is a general application to diverse operations without requiring much knowledge relating to an operation as the subject of analysis.

What is claimed is:

1. An information processing apparatus, comprising:
a storage unit for storing information relating to an execution of an operation and storing a transition which indicates a handling corresponding to the information;
a flow processing unit for building up a work flow which is expressed by using the information and the transition based on the information necessary for obtaining a final product dealt with by the operation; and
an output unit for outputting the work flow.

2. The information processing apparatus according to claim 1, wherein
said storage unit includes
a first storage unit for storing an information name, by correlation with its value, relating to information used for an operation execution,
a second storage unit for storing a category of a transition which is a handling corresponding to the information,
a third storage unit for managing a correlation between
a name of the transition and the category,
a fourth storage unit for defining a rule of the handling corresponding to the information in the transition, and
a fifth storage unit for storing a correlation of the rule among each piece of the information, the transition at an input destination and/or at an output source of the aforementioned information, and the transition.

3. The information processing apparatus according to claim 1, wherein
said flow processing unit further carries out the processing of outputting said information, as terminal information, in which said transition of said output source does not exist, into said work flow so as to be distinguishable from other information.

4. The information processing apparatus according to claim 1, wherein
said flow processing unit further carries out the processing of outputting each of said transitions within said work flow so as to be distinguishable per each of said categories.

5. The information processing apparatus according to claim 1, wherein
said flow processing unit further carries out the processing of outputting, to said output unit, by totaling the number of said transitions existing in a path for each path from said information as a start point to said final product in said work flow.

6. The information processing apparatus according to claim 1, wherein
said flow processing unit further carries out the processing of
detecting a path, as a sub-flow, reaching said transition specified by way of said input unit from said information which constitutes a start point, and
outputting the number of the sub-flows as a degree of multiplexing to said output unit in said work flow.

7. The information processing apparatus according to claim 1, wherein
said flow processing unit further carries out the processing of
detecting a path, as a sub-flow, reaching said transition specified by way of said input unit from said information which constitutes a start point,
totaling the number of the transitions included in the sub-flow and outputting to said output unit as a degree of congestion in said work flow.

8. An information processing method, comprising:
a first step for building up a work flow for expressing a flow of information by using a final product dealt with by an operation, the information necessary for obtaining the final product and a transition expressing a handling corresponding to the information; and
a second step for analyzing the operation based on the work flow.

9. The information processing method according to claim 8, wherein
said second step is for evaluating said operation based on the number of pieces of said information external to the ones which are generated by the operation.

10. The information processing method according to claim 8, wherein
said first step is for building up said work flow by categorizing said transition according to a category of a handling corresponding to said information at the aforementioned transition, and
said second step is for visually displaying said transition within the work flow so as to be distinguishable per each of the categories.

11. The information processing method according to claim 8, wherein
said first step is for building up said work flow by categorizing said transition according to a category of a handling corresponding to said information at the aforementioned transition, and
said second step is for totaling the number of the transitions per each of the categories and outputting a result of totaling the number of transitions per each of the categories.

12. The information processing method according to claim 8, wherein
said second step is for totaling the number of said transitions which a relevant path passes through per each of a plurality of paths from said information, which constitutes a start point within said work flow, to said final product, and
outputting the number of the transitions per each of the paths.

13. The information processing method according to claim 8, wherein
said second step is for detecting, as a sub-flow, a path from said information, which constitutes a start point within said work flow, to one said transition, and
outputting the number of the sub-flows and/or the number of the transitions included in each of the sub-flows.

14. The information processing method according to claim 8, wherein
said second step is for detecting, as a sub-flow, a path from said information, which constitutes a start point within said work flow, to one said transition, and
detecting and outputting a congestion of the information in the work flow based on the number of the transitions included in each of the sub-flows and weight information, being added to each of the transitions, for indicating a handling volume of the information.

15. A signal for carrying a program which makes a computer execute:
a first step for building up a work flow for expressing a flow of information by using a final product dealt with by an operation, the information necessary for obtaining the final product and a transition expressing a handling corresponding to the information; and
a second step for analyzing the operation based on the work flow.

16. The signal for carrying a program according to claim 15, wherein
said second step is for visually displaying the number of the pieces of said information external to the ones which are generated by the operation by extraction from said work flow.

17. The signal for carrying a program according to claim 15, wherein
said first step is for building up said work flow by categorizing said transition according to a category of a handling corresponding to said information at the aforementioned transition, and
said second step is for displaying said transition within the work flow so as to be distinguishable per each of the categories.

18. The signal for carrying a program according to claim 15, wherein
said first step is for building up said work flow by categorizing said transition according to a category of a handling corresponding to said information at the aforementioned transition, and
said second step is for totaling the number of the transitions per each of the categories and outputting a result of totaling the number of transitions per each of the categories.

19. The signal for carrying a program according to claim 15, wherein
said second step is for carrying out at least either one of the processing of
detecting a path, as a sub-flow, a path from said information, which constitutes a start point within said work flow, to one said transition and displaying the number of the sub-flows, or
detecting a path, as a sub-flow, a path from said information, which constitutes a start point within said work flow, to one said transition and displaying the number of the transitions included in each of the sub-flows.

20. The signal for carrying a program according to claim 15, wherein
said second step is for detecting, as a sub-flow, a path from said information, which constitutes a start point within said work flow, to one said transition, and detecting and outputting a congestion of the information in the work flow based on the number of the transitions included in each of the sub-flows and weight information, being added to each of the transitions, for indicating a handling volume of the information.
